(19) United States
(12) Patent Application Publication
(10) Pub. No.: US 2026/0358597 A1
(43) Pub. Date: Nov. 12, 2026

(54) OPTICAL SYSTEM AND CAMERA DEVICE COMPRISING SAME

(71) Applicant: LG INNOTEK CO., LTD., Seoul (KR)

(72) Inventor: Ju Yong SHIM, Seoul (KR)

(21) Appl. No.: 19/111,909

(22) PCT Filed: Sep. 27, 2023
(86) PCT No.: PCT/KR2023/014971

§ 371 Date: Mar. 14, 2025

(30) Foreign Application Priority Data
Sep. 29, 2022 (KR) 10-2022-0124158

(51) Int. Cl. G02B 13/00

(52) U.S. Cl. CPC G02B 13/0045

(57) ABSTRACT

An optical system according to an embodiment of the present invention comprises first to nth lenses and an image sensor arranged sequentially from an object side to an image side, wherein the first lens has positive power and has the smallest effective area diameter or the greatest thickness among the first to nth lenses, the first to (n−1)th lenses have positive composite power, and the nth lens has negative power, at least one of the object-side surface and the image-side surface of the nth lens includes a critical point at which the tilt angle is 0, the sag values of the critical point of the X-axis, the critical point of the Y-axis, and the critical point in one direction between the X-axis and the Y-axis of the at least one of the object-side surface and the image-side surface of the nth lens are different from each other, the X-axis is perpendicular to the optical axis and parallel to one side of the image sensor, the Y-axis is perpendicular to the optical axis and the X-axis, and n is an integer of 6 or more.

### TECHNICAL FIELD

Embodiments of the present invention relates to an optical system and a camera device including the same.

### BACKGROUND ART

As the performance of a camera device built in a mobile terminal progresses, the demand for higher resolution in the camera device in the mobile terminal is also increasing. In order to improve the performance of the camera device, the high performance of the optical system and an image sensor is required. However, due to a narrow space in the mobile terminal, the high performance of the optical system and the image sensor is not easy.

Specifically, the need for miniaturization of the camera device is further increasing. As the camera device becomes smaller, an amount of light which reaches the image sensor through the optical system may decrease. Accordingly, an F-number which determines the brightness of an image may increase, and an amount of light which reaches a peripheral region of the image sensor may decrease compared to an amount of light which reaches a central region of the image sensor

### DISCLOSURE

### Technical Problem

The technical object to be achieved by the present invention is to acquire a camera module with a small F-number, a large field of view, and a high relative illumination while being implemented in a small size.

The objects to be achieved in the embodiment is not limited thereto, and it can be said that the objects or effects that can be understood from the solution to the problem described below or the specific contents for implementing the invention are also included.

### Technical Solution

An optical system according to one embodiment of the present invention includes first to nth lenses and an image sensor, which are sequentially disposed from an object side to an image side, wherein the first lens has positive power and is a lens having the smallest diameter of an effective region and the greatest thickness among the first to nth lenses, the first to n−1th lenses have positive composite power, the nth lens has negative power, at least one of an object-side surface and an image-side surface of the nth lens includes a critical point at which a tilt angle is 0, sag values of a critical point of an X-axis, a critical point of a Y-axis, and a critical point in one direction between the X-axis and the Y-axis of at least one of the object-side surface and the image-side surface of the nth lens are different from each other, the X-axis is perpendicular to the optical axis and parallel to one side of the image sensor, the Y-axis is perpendicular to the optical axis and the X-axis, and n is an integer greater than or equal to 6.

An optical system according to another embodiment of the invention includes first to nth lenses and an image sensor, which are sequentially disposed from an object side to an image side, wherein the first lens has positive power, a ratio of a diameter of an effective region of the first lens to a diagonal length of the image sensor is 0.15 or more and 0.35 or less, the first to n−1th lenses have positive composite power, the nth lens has negative power, at least one of an object-side surface and an image-side surface of the nth lens includes a critical point at which a tilt angle is 0, sag values of a critical point of an X-axis, a critical point of a Y-axis, and a critical point in one direction between the X-axis and the Y-axis of at least one of the object-side surface and the image-side surface of the nth lens are different from each other, the X-axis is perpendicular to the optical axis and parallel to one side of the image sensor, the Y-axis is perpendicular to the optical axis and the X-axis, and n is an integer greater than or equal to 6.

A center thickness on the optical axis may be the greatest in the first lens among the first to nth lenses, and a thickness at an end of the effective region may be the next greatest in the first lens after the nth lens among the first to nth lenses.

When a center thickness on the optical axis of the first lens may be CT1, a distance from the object-side surface of the first lens to the image sensor may be TTL, and the sum of the center thicknesses on the optical axis of the first lens to the nth lens is CT_1n, CT1/TTL may be 0.1 or more and 0.2 or less and CT1/CT_1n may be 0.2 or more and 0.35 or less.

n may be 6.

A deviation between the sag value of the critical point of the X-axis and a sag value of a critical point in a direction formed at 45 degrees from the X-axis of at least one of the object-side surface and the image-side surface of the nth lens may be greater than a deviation between the sag value of the critical point of the X-axis and the sag value of the critical point of the Y-axis of at least one of the object-side surface and the image-side surface of the nth lens.

An absolute value of a sag value of a critical point in a direction formed at 45 degrees from the X-axis may be the smallest among an absolute value of the sag value of the critical point of the X-axis, an absolute value of the sag value of the critical point of the Y-axis, and the absolute value of the sag value of the critical point in the direction formed at 45 degrees from the X-axis of at least one of the object-side surface and the image-side surface of the nth lens.

An absolute value of a deviation between at least two of a sag value of the X-axis, a sag value of the Y-axis, a sag value in a direction formed at 45 degrees from the X-axis, and a sag value in a diagonal direction of the image sensor from a point of 50% of the effective region to an end of the effective region of at least one of the object-side surface and the image-side surface of the nth lens may be 2 μm or more.

Both an object-side surface and an image-side surface of the sixth lens may have a circular asymmetrical shape.

The second lens may have negative refractive power, the third lens may have positive refractive power, the fourth lens may have negative refractive power, and the fifth lens may have positive refractive power.

An aperture may be disposed on the front of the object-side surface of the first lens, and when the aperture is closed, the shortest distance between the aperture and the object-side surface of the first lens may be 0.2 mm or less.

A diameter of the effective region of the image-side surface of the sixth lens may be 1.2 times or more a diameter of the effective region of the object-side surface of the first lens.

The object-side surface or image-side surface of at least one of the first to n−1th lenses may include a critical point.

An object-side surface and an image-side surface of the fourth lens each include a critical point, and a distance between the optical axis and the critical point of the object-side surface of the fourth lens may be 0.95 to 1.05 times a distance between the optical axis and the critical point of the image-side surface of the fourth lens.

A center thickness of the second lens or a center thickness of the fourth lens may be the smallest among center thicknesses of the first to nth lenses.

An F-number may be 2.3 or less, a field of view (FOV) may be 85 degrees or more, and a relative illumination (RI) may be 30% or more.

### Advantageous Effects

According to the embodiment of the present invention, a camera device with a small F-number, a large field of view (FOV), and a high relative illumination (RI) while being implemented in a small size can be acquired.

According to the embodiment of the present invention, a camera device with a F-number of 2.3 or less, an FOV of 85 degrees or more, and an RI in 1 field of 30% or more while being implemented in a small size can be acquired.

According to the embodiment of the present invention, a camera device providing an image with a high RI while minimizing a head size exposed to the outside can be acquired. That is, in order to minimize the head size exposed to the outside, a camera device providing an image with a high RI around a sensor while designing a diameter of a first lens, that is, the lens disposed closest to an object side, to be small can be acquired.

According to the embodiment of the present invention, an optical system and a camera device with excellent manufacturing performance can be acquired.

### DESCRIPTION OF DRAWINGS

FIGS. 1 to 3 show an optical system according to one embodiment of the present invention.

FIG. 4 shows a relationship between a first lens and an aperture in the optical system according to the embodiment of the present invention.

FIGS. 5 and 6 are views for describing a relative illumination.

FIG. 7 is design data showing distances between lens surfaces according to a distance in a Y direction from an optical axis in the optical system according to the embodiment of the present invention.

FIG. 8 is design data showing sag values of lens surfaces according to a distance in the Y direction from the optical axis in the first to fifth lenses of the optical system according to the embodiment of the present invention.

FIG. 9 is design data showing sag values of lens surfaces according to a distance in the X direction, the Y direction, a diagonal direction, and a 45-degree direction from the optical axis in a sixth lens of the optical system according to the embodiment of the present invention.

FIG. 10 is design data showing tilt angles of lens surfaces according to a distance in the Y direction from the optical axis in the optical system according to the embodiment of the present invention.

FIG. 11 shows an image-side surface of the sixth lens and an image sensor of an optical system according to one embodiment of the present invention.

FIG. 12 shows a modulation transfer function (MTF) using the optical system according to one embodiment of the present invention.

FIG. 13 shows a distortion grid using the optical system according to one embodiment of the present invention.

FIG. 14 is a cross-sectional view of an optical system according to a comparative example.

FIG. 15 is a view showing a portion of a mobile terminal to which a camera device according to one embodiment of the present invention is applied.

### MODES OF THE INVENTION

Hereinafter, exemplary embodiments according to the present invention will be described in detail with reference to the accompanying drawings.

However, the technical spirit of the present invention is not limited to some embodiments to be described, but may be implemented in various different forms, and one or more of the components between the embodiments may be selectively combined and substituted within the technical spirit of the present invention.

Further, terms (including technical and scientific terms) used in the embodiments of the present invention may be interpreted as meanings which may be generally understood by those skilled in the art unless explicitly specifically defined and described, and the meanings of the generally used terms such as terms defined in a dictionary may be understood in consideration of contextual meanings in the related art.

In addition, the terms used in the embodiments of the present invention are provided not to limit the present invention but to describe the embodiments.

In the present specification, a singular form may also include a plural form unless otherwise specified in the phrase, and may include one or more of all possible combinations of A, B, and C when disclosed as at least one (or one or more) of “A, B, and C.”

Further, terms such as first, second, A, B, (a), (b), and the like may be used to describe the components of the embodiment of the present invention.

These terms are only provided to distinguish one component from another component, and the essence, sequence, order, or the like of the elements are not limited by these terms.

Further, when a specific component is disclosed as being “connected,” “coupled,” or “linked” to another component, this may not only include a case of the component being directly connected, coupled, or linked to the other component but also a case of the component being connected, coupled, or linked to the other component by another component between the element and the other component.

In addition, when one component is disclosed as being formed “on or under” another component, the term “on or under” includes both a case in which the two components are in direct contact with each other and a case in which at least another component is disposed between the two components (indirectly). In addition, when the term “on or under” is expressed, a meaning of not only an upward direction but also a downward direction may be included based on one component.

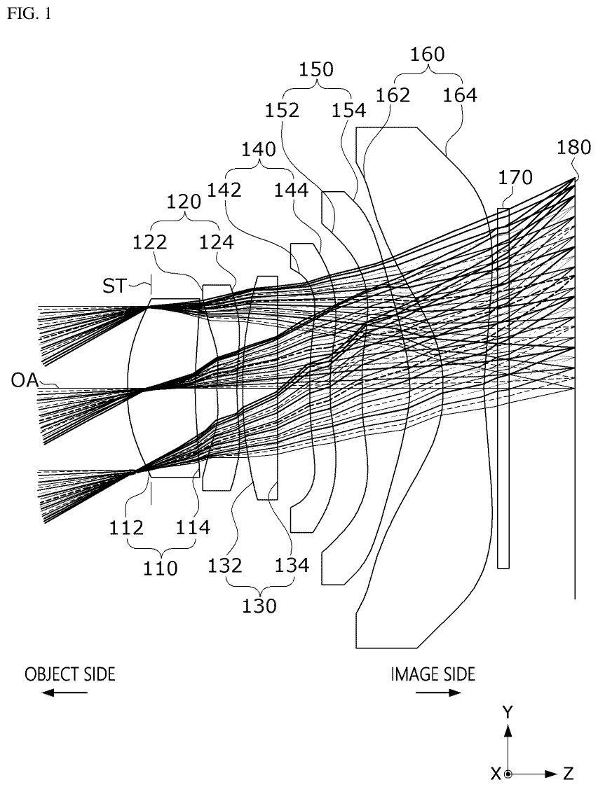

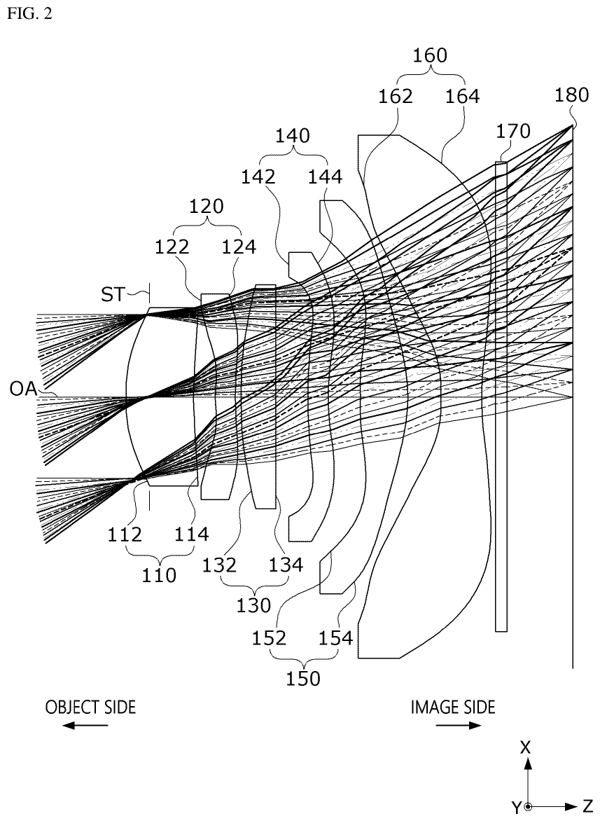

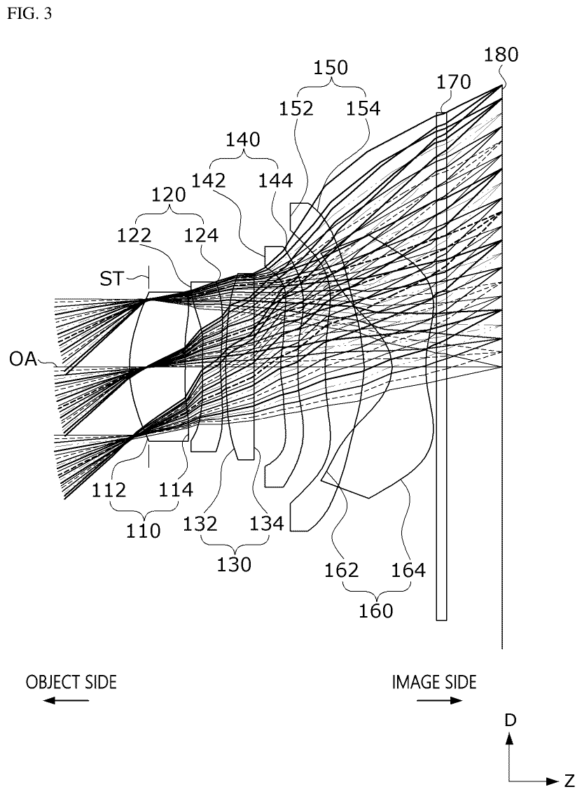

FIGS. 1 to 3 show an optical system according to one embodiment of the present invention. FIG. 1 is a cross-sectional view in a YZ direction, FIG. 2 is a cross-sectional view in an XZ direction, and FIG. 3 is a cross-sectional view in a DZ direction. Here, a Z direction is a direction of the optical axis, an X direction is a direction perpendicular to the direction of the optical axis and parallel to one side of an image sensor, a Y direction is a direction perpendicular to the direction of the optical axis and the X direction, and a D direction is a direction perpendicular to the direction of the optical axis and between the X direction and the Y direction. Hereinafter, an example in which a ratio of an X-axis length to a Y-axis length of the image sensor is 4 to 3 is described, but is not limited thereto.

Referring to FIG. 1, an optical system 100 according to the embodiment of the present invention includes a first lens 110, a second lens 120, a third lens 130, a fourth lens 140, a fifth lens 150, a sixth lens 160, a filter 170, and an image sensor 180, which are sequentially disposed from an object side to an image side.

Although not shown, a right-angled prism may be further disposed in front of the first lens 110.

At least one of the first lens 110, the second lens 120, the third lens 130, the fourth lens 140, the fifth lens 150, and the sixth lens 160 may include an effective region and a non-effective region. The effective region may be a region through which light incident on the lens passes, that is, a region through which the incident light is refracted to implement optical characteristics. In the present specification, an effective diameter may mean a diameter of the effective region through which effective light is incident on each surface of each lens. In the present specification, a numerical value of the effective diameter may have a certain error range. For example, a range of ±0.4 mm may be considered as the effective region for the numerical value of the effective diameter presented in the present specification, and the range of ±0.4 mm may be interpreted as the effective diameter for the numerical value of the effective diameter presented in the present specification. The non-effective region is disposed at a perimeter of the effective region and may be a region where light is not incident, that is, a region unrelated to optical characteristics. The non-effective region may be a region fixed to a barrel which accommodates a lens, or the like.

According to the embodiment of the present invention, the filter 170 and the image sensor 180 may be sequentially disposed behind the sixth lens 160. In this case, the filter 170 may be an infrared (IR) filter. Accordingly, the filter 170 may block near-infrared rays, for example, light with a wavelength of 700 nm to 1100 nm, from light incident on a camera device. Alternatively, the filter 170 may be a filter which transmits IR rather than a filter which blocks IR. Further, the image sensor 180 may be connected to a printed circuit board.

According to the embodiment of the present invention, the first lens 110, the second lens 120, the third lens 130, the fourth lens 140, the fifth lens 150, and the sixth lens 160 may be sequentially disposed along an optical axis. According to the embodiment of the present invention, the first lens 110, the second lens 120, the third lens 130, the fourth lens 140, the fifth lens 150 may be circular symmetrical lenses, and the sixth lens 160 may be a circular asymmetrical lens. The first lens 110, the second lens 120, the third lens 130, the fourth lens 140, the fifth lens 150, and the sixth lens 160 may each be made of plastic or glass.

The first lens 110 has positive refractive power and includes an object-side surface 112 and an image-side surface 114, and the object-side surface 112 of the first lens 110 may be convex toward the object side and the image-side surface 114 may be concave toward the image side. Here, a case in which the surface of the lens is convex may mean that the surface of the lens in the region corresponding to the optical axis has a convex shape, and a case in which the surface of the lens is concave may mean that the surface of the lens in the region corresponding to the optical axis has a concave shape. Here, the region corresponding to the optical axis may mean an optical axis region or a paraxial region. Furthermore, the case in which the surface of the lens is convex toward the object side may mean that the surface of the lens is concave toward the image side, and the case in which the surface of the lens is convex toward the image side may mean that the surface of the lens is concave toward the object side.

The second lens 120 has negative refractive power and includes an object-side surface 122 and an image-side surface 124, and the object-side surface 122 of the second lens 120 may be concave toward the object side and the image-side surface 124 may be concave toward the image side.

The third lens 130 has positive refractive power and includes an object-side surface 132 and an image-side surface 134, and the object-side surface 132 of the third lens 130 may be convex toward the object side and the image-side surface 134 may be convex toward the image side.

The fourth lens 140 has negative refractive power and includes an object-side surface 142 and an image-side surface 144, and the object-side surface 142 of the fourth lens 140 may be convex toward the object side and the image-side surface 144 may be concave toward the image side.

The fifth lens 150 has positive refractive power and includes an object-side surface 152 and an image-side surface 154, and the object-side surface 152 of the fifth lens 150 is convex toward the object side and the image-side surface 154 is convex toward the image side.

The sixth lens 160 has negative refractive power and includes an object-side surface 162 and an image-side surface 164, and the object-side surface 162 of the sixth lens 160 may be concave toward the object side and the image-side surface 164 may be concave toward the image side.

As in the embodiment of the present invention, when the first lens 110 has positive refractive power, the second lens 120 has negative refractive power, the third lens 130 has positive refractive power, the fourth lens 140 has negative refractive power, the fifth lens 150 has positive refractive power, and the sixth lens 160 has negative refractive power, chromatic aberration may be corrected, and light may uniformly reach the periphery of the image sensor while a process in which light is collected and spread is repeated.

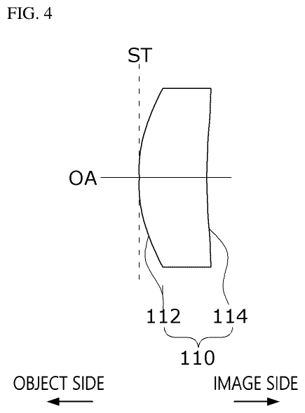

FIG. 4 shows a relationship between a first lens and an aperture in the optical system according to the embodiment of the present invention.

Referring to FIG. 4, an aperture ST is disposed closer to the object side than the first lens 110. The aperture ST may adjust an amount of light incident on the optical system 100. Accordingly, the optical system 100 according to the embodiment of the present invention includes an aperture ST, a first lens 110, a second lens 120, a third lens 130, a fourth lens 140, a fifth lens 150, and a sixth lens 160, which are sequentially disposed from an object side to an image side. According to the embodiment of the present invention, the aperture ST is disposed closer to the object side than the object-side surface 112 of the first lens 110. In a state in which the aperture ST is closed, the aperture ST may be disposed on the front of a region corresponding to the optical axis of the object-side surface 112 of the first lens 110. For example, in a state in which the aperture ST is closed, the aperture ST may be disposed on the front of a region corresponding to an optical axis OA of the object-side surface 112 of the first lens 110 at a distance of 0.2 mm or less, preferably 0.1 mm or less, more preferably 0.05 mm or less, and even more preferably 0.01 mm or less from the region corresponding to the optical axis OA of the object-side surface 112 of the first lens 110. In a case in which the aperture ST is not a drivable aperture, the shortest distance between a position where the aperture is disposed and the object-side surface 112 of the first lens 110 may be 0.2 mm or less.

According to the embodiment of the present invention, an entrance pupil diameter (EPD) of the optical system 100 may be similar to an effective diameter (ED_{L1S1}) of the object-side surface 112 of the first lens 110. The EPD of the optical system 100 may be 0.9 to 1.1 times, preferably 0.95 to 1.05 times, and more preferably 0.97 to 1.03 times the effective diameter (ED_{L1S1}) of the object-side surface 112 of the first lens 110. Accordingly, since an area of the object-side surface 112 of the first lens 110 exposed to the outside may be minimized, a head size of the optical system 100 may be minimized.

Referring to FIG. 1 again, the object-side surface 112 of the first lens 110 has the smallest effective diameter among the first to sixth lenses 110, . . . , and 160. For example, the effective diameter (ED_{L1S1}) of the first lens 110 may be 1.422 mm to 1.738 mm, preferably 1.501 mm to 1.659 mm, and more preferably 1.533 mm to 1.627 mm.

According to the embodiment of the present invention, the effective diameter of the object-side surface 112 of the first lens 110 may be smaller than a length in a diagonal direction of the image sensor 180. For example, a ratio of the effective diameter (ED_{L1S1}) of the object-side surface 112 of the first lens 110 to a length (2*H_{imageD}) in the diagonal direction of the image sensor 180 may be 0.15 to 0.35, preferably 0.2 to 0.3, and more preferably 0.22 to 0.26. When the effective diameter (ED_{L1S1}) of the first lens 110 and the length (2*H_{imageD}) in the diagonal direction of the image sensor 180 satisfy this, a design that minimizes the head size of the optical system exposed to the outside may be made within a range in which the first lens 110 can be manufactured. Since it may be difficult to manufacture the first lens when the above ratio is below the lower limit, and the object-side surface of the first lens may be exposed to the outside when the above ratio exceeds the upper limit, it may be difficult to apply the design to applications for minimizing the head size.

According to the embodiment of the present invention, the effective diameter of the object-side surface 112 of the first lens 110 may be 0.3 to 0.4 times, preferably 0.325 to 0.385 times, and more preferably 0.35 to 0.7 times the TTL of the optical system. When the effective diameter (ED_{L1S1}) and TTL of the first lens 110 satisfy this, a design that minimizes the head size of the optical system exposed to the outside may be made within a range in which the first lens 110 can be manufactured. Since it may be difficult to manufacture the first lens when a numerical value is below the lower limit, and the object-side surface of the first lens may be exposed to the outside when a numerical value exceeds the upper limit, it may be difficult to apply the design to applications for minimizing the head size.

When the aperture ST is disposed on the front of the object-side surface 112 of the first lens 110, since the amount of light incident on the first lens 110 may be maximized while minimizing the area of the optical system 100 exposed to the outside, the optical system 100 may be implemented in a compact size. For example, the camera device including the optical system 100 according to the embodiment of the present invention may be implemented so as not to be exposed to the user's naked eye. For example, the camera device including the optical system 100 according to the embodiment of the present invention may be implemented to be disposed on the front of a mobile terminal. For example, the camera device including the optical system 100 according to the embodiment of the present invention may be implemented to be disposed under a display.

Meanwhile, as the effective diameter of the first lens 110 becomes smaller, the head size exposed to the outside may be minimized. However, as the effective diameter of the first lens 110 becomes smaller, it may be difficult to manufacture the first lens 110, and the amount of light incident on the optical system 100 may be insufficient. Accordingly, it is necessary to consider conditions for brightening the image by reducing an F number and improving a ratio of an amount of light incident on the periphery of the image sensor to an amount of light incident on the center of the image sensor, that is, a relative illumination (RI) when designing the optical system including the first lens 110, while manufacture of the first lens is easy.

Here, the center of the image sensor means a region close to a 0 field of the image sensor, and the periphery of the image sensor means a region close to a 1 field of the image sensor.

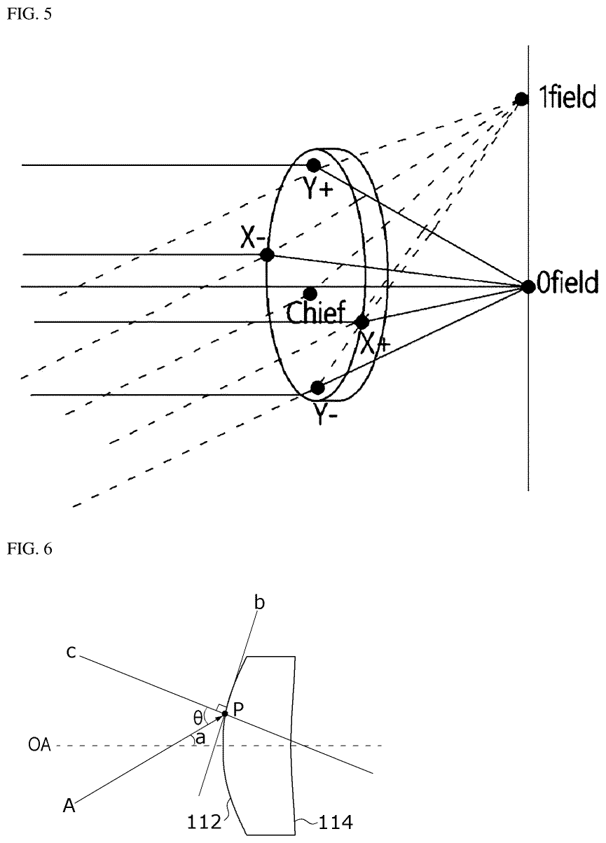

FIGS. 5 and 6 are views for describing the relative illumination.

Referring to FIG. 5, it can be seen that a region which reaches the image sensor varies depending on an incident angle of light incident from the object side. That is, the image sensor is divided into a 0 field region which is the center of the image sensor and a 1 field region which is the farthest location from the center of the image sensor, and it can be seen that light reaches closer to the 1 field region (the periphery) of the image sensor as the incident angle of the light is larger, and the light reaches closer to the 0 field region (the center) as the incident angle of the light is smaller.

Referring to FIG. 6, it is assumed that a first ray A is a ray parallel to a field of view (FOV) of the optical system 100. The first ray A may be incident on the object-side surface 112 of the first lens 110 to have an angle of a with respect to the optical axis OA of the first lens 110. In this case, an angle formed by the first ray A and a normal line (line c) at a point P where the first ray A and the object-side surface 112 of the first lens 110 contact each other may be defined as an incident angle θ.

According to the embodiment of the present invention, the lenses forming the optical system 100 are designed to reduce the F-number and improve the RI.

Tables 1 and 2 below show the optical characteristics of the lenses included in the optical system according to the embodiment of the present invention, Table 3 shows the Qcon coefficients of the first to fifth lenses included in the optical system according to the embodiment of the present invention, and Table 4 shows the Zernike coefficient of the sixth lens included in the optical system according to the embodiment of the present invention.

TABLE 1

| | Lens | | | Radius of | | | Effective |
|---|---|---|---|---|---|---|---|
| Lens | Surface | | Critical | Curvature | Curvature | Thickness | Diameter |
| Number | Number | Shape | Point | (R, mm) | (C, mm) | (mm) | (mm) |
| Aperture | ST | | | | | 0.000 | 1.700 |
| First | 112 | Convex | Not Present | 1.6791 | 0.5956 | 0.650 | 1.580 |
| Lens | 114 | Concave | Present | 4.5238 | 0.2211 | 0.208 | 1.730 |
| Second | 122 | Concave | Present | 70.0285 | 0.0143 | 0.200 | 1.734 |
| Lens | 124 | Concave | Present | 6.4659 | 0.1547 | 0.057 | 1.951 |
| Third | 132 | Convex | Not Present | 4.8047 | 0.2081 | 0.334 | 2.114 |
| Lens | 134 | Convex | Present | −117.1980 | −0.0085 | 0.304 | 2.143 |
| Fourth | 142 | Convex | Present | 2.2104 | 0.4524 | 0.200 | 2.306 |
| Lens | 144 | Concave | Present | 1.9054 | 0.5248 | 0.310 | 2.786 |
| Fifth | 152 | Convex | Present | 3.2862 | 0.3043 | 0.463 | 3.171 |
| Lens | 154 | Convex | Not Present | −1.6051 | −0.6230 | 0.280 | 3.787 |
| Sixth | 162 | Concave | Not Present | −1.5325 | −0.6525 | 0.384 | 4.362 |
| Lens | 164 | Concave | Present | 1.2067 | 0.8287 | 0.179 | 5.048 |
| Filter | 172 | | | | | 0.110 | |
| | 174 | | | | | 0.640 | |
| Sensor | 180 | | | | | | |

TABLE 2

| | Lens | Focal | | | | Center | Air | Edge |
|---|---|---|---|---|---|---|---|---|
| Lens | Surface | Length | | Abbe | Refractive | Thickness | Gap | Thickness |
| Number | Number | (f, mm) | Power | Number | Index | (mm) | (mm) | (mm) |
| First | 112 | 4.6039 | 0.22 | 55.7074 | 1.5371 | 0.6500 | | 0.4645 |
| Lens | 114 | | | | | | 0.2082 | |
| Second | 122 | −10.3403 | −0.10 | 18.1193 | 1.6898 | 0.2000 | | 0.2788 |
| Lens | 124 | | | | | | 0.0570 | |
| Third | 132 | 8.6016 | 0.12 | 55.7074 | 1.5371 | 0.3339 | | 0.2062 |
| Lens | 134 | | | | | | 0.3043 | |
| Fourth | 142 | −29.7103 | −0.03 | 25.9602 | 1.6206 | 0.2000 | | 0.2218 |
| Lens | 144 | | | | | | 0.3104 | |
| Fifth | 152 | 2.0765 | 0.48 | 55.7074 | 1.5371 | 0.4634 | | 0.2005 |
| Lens | 154 | | | | | | 0.3173 | |
| Sixth | 162 | −1.5971 | −0.63 | 55.7074 | 1.5371 | 0.4000 | | 0.4064 |
| Lens | 164 | | | | | | | |
| Filter | 172 | | | | | | | |
| | 174 | | | | | | | |
| Sensor | 180 | | | | | | | |

TABLE 3

| | First Lens | | Second Lens | | Third Lens |
|---|---|---|---|---|---|
| Lens Surface | 112 | 114 | 122 | 124 | 132 |
| Number | | | | | |
| Y-axis Radius | 1.679 | 4.524 | 70.028 | 6.466 | 4.805 |
| Normalization | 0.784 | 0.825 | 0.885 | 0.966 | 1.097 |
| radius | | | | | |
| Conic Constant | −0.324 | −22.060 | 99.000 | −15.554 | −2.330 |
| 4th order | −2.04E−03 | −3.78E−02 | −1.46E−01 | −1.17E−01 | 2.00E−02 |
| 6th order | −1.99E−04 | −8.14E−03 | −1.34E−02 | −6.49E−03 | 1.71E−03 |
| 8th order | −1.81E−04 | −7.68E−04 | −2.11E−03 | 5.35E−04 | 3.17E−03 |
| 10th order | 4.40E−05 | −1.19E−04 | −1.08E−03 | −7.14E−04 | −6.37E−04 |
| 12th order | −2.85E−05 | −6.65E−06 | −7.88E−04 | −1.20E−04 | −3.92E−04 |
| 14th order | 1.88E−05 | −2.12E−05 | −4.82E−04 | −3.14E−04 | −9.52E−04 |
| 16th order | −1.09E−05 | 3.36E−06 | −2.15E−04 | 3.52E−05 | −1.09E−04 |
| 18th order | 1.30E−05 | −4.65E−06 | −7.69E−05 | −5.44E−06 | −8.19E−05 |
| 20th order | −8.78E−06 | −4.20E−06 | −2.75E−05 | 1.77E−05 | 1.18E−05 |
| | Third Lens | Fourth Lens | | Fifth Lens | |
| Lens Surface | 134 | 142 | 144 | 152 | 154 |
| Number | | | | | |
| Y-axis Radius | −117.198 | 2.210 | 1.905 | 3.286 | −1.605 |
| Normalization | 1.100 | 1.103 | 1.304 | 1.526 | 1.647 |
| radius | | | | | |
| Conic Constant | 33.604 | −93.430 | −29.736 | −31.294 | −1.482 |
| 4th order | −7.54E−03 | −1.28E−01 | −3.23E−01 | −5.23E−01 | 4.22E−01 |
| 6th order | 2.23E−02 | −4.98E−02 | 4.55E−03 | −3.58E−02 | −1.12E−01 |
| 8th order | 1.06E−02 | −3.60E−03 | 7.04E−03 | 2.16E−02 | 1.35E−02 |
| 10th order | 5.24E−03 | −5.23E−03 | 2.60E−03 | 4.51E−03 | 2.24E−03 |
| 12th order | 2.32E−03 | 3.34E−04 | 4.62E−04 | −5.54E−04 | −8.30E−04 |
| 14th order | 6.42E−04 | −7.00E−04 | −1.15E−04 | 5.66E−04 | −5.56E−04 |
| 16th order | 4.26E−05 | 2.82E−04 | −1.13E−04 | 2.59E−04 | 5.88E−04 |
| 18th order | 2.11E−05 | −8.55E−05 | −7.19E−05 | −1.23E−04 | −2.12E−04 |
| 20th order | −5.37E−06 | 9.20E−05 | 2.28E−05 | −6.50E−05 | 2.11E−05 |

TABLE 4

Sixth Lens

| | | |
|---|---|---|
| Lens Surface Number | 162 | 144 |
| Y-axis Radius | −1.532 | 1.207 |
| Normalization radius | 1.930 | 3.013 |
| Conic Constant | −0.862 | −4.621 |
| 1st order | 1.95E−01 | −1.25E+00 |
| 4th order | 1.53E−03 | −1.75E−01 |
| 5th order | 2.97E−01 | −1.62E+00 |
| 11th order | −4.65E−03 | 1.29E−01 |
| 12th order | 8.69E−04 | −1.72E−01 |
| 13th order | 1.26E−01 | −4.32E−01 |
| 22nd order | −7.78E−05 | −1.54E−01 |
| 23rd order | −1.06E−03 | 9.29E−02 |
| 24th order | 7.83E−04 | −9.59E−02 |
| 25th order | −1.37E−02 | −1.24E−01 |
| 37th order | −2.74E−04 | 3.59E−02 |
| 38th order | 2.74E−04 | −5.61E−02 |
| 39th order | −5.68E−05 | 3.63E−02 |
| 40th order | 2.74E−04 | −2.82E−02 |
| 41st order | −1.72E−03 | −4.43E−02 |
| 57th order | 5.98E−05 | −1.06E−03 |
| 58th order | −1.56E−04 | 6.83E−03 |
| 59th order | 3.68E−05 | −1.07E−02 |
| 60th order | −3.33E−04 | 4.52E−03 |
| 61st order | 1.56E−04 | −2.16E−03 |

In Table 1, the thickness (mm) represents a distance from each lens surface to the next lens surface. For example, the thickness disclosed for the aperture ST represents a distance from the aperture ST to the object-side surface 112 of the first lens 110. Here, when the aperture ST is a drivable aperture, the distance from the aperture ST to the object-side surface 112 of the first lens 110 may mean the distance from the aperture ST to the object-side surface 112 of the first lens 110 in a state in which the aperture ST is closed. The thickness disclosed for the object-side surface 112 of the first lens 110 represents a distance from the object-side surface 112 to the image-side surface 114 of the first lens 110. In Table 1, the thickness (mm) may mean a distance from the optical axis. Specifically, the thickness disclosed for the object-side surface 112 of the first lens 110 may represent a distance between a center of curvature of the object-side surface 112 and a center of curvature of the image-side surface 114 of the first lens 110. The thickness disclosed for the image-side surface 114 of the first lens 110 represents a distance from the image-side surface 114 of the first lens 110 to the object-side surface 122 of the second lens 120. Specifically, the thickness disclosed for the image-side surface 114 of the first lens 110 represents a distance between a center of curvature of the image-side surface 114 of the first lens 110 and a center of curvature of the object-side surface 122 of the second lens 120.

In Table 1 or Table 2, a center thickness CT may mean a thickness on the optical axis of each lens. For example, a center thickness of the first lens 110 may represent the distance between the center of curvature of the object-side surface 112 and the center of curvature of the image-side surface 114 in the first lens 110. An air gap may mean a distance between neighboring lenses on the optical axis. For example, an air gap of the first lens 110 may represent a distance between the center of curvature of the image-side surface 114 of the first lens 110 and the center of curvature of the object-side surface 122 of the second lens 120.

The thicknesses disclosed for the object-side surfaces of the first to fifth lenses, which are circular symmetrical lenses, in Table 1 may match the center thicknesses of the first to fifth lenses in Table 2, and the thicknesses disclosed for the image-side surface of the first to fourth lenses, which are circular symmetrical lenses, in Table 1 may match the air gaps of the first to fourth lenses in Table 2. However, since the object-side surface 162 and the image-side surface 164 of the sixth lens 160 have a circular asymmetrical shape, there may be an offset. Accordingly, the thickness of the image-side surface 154 of the fifth lens 150 disclosed in Table 1, that is, a distance between the image-side surface 154 of the fifth lens 150 and the object-side surface 162 of the sixth lens 160 may not match the air gap of the fifth lens 150 disclosed in Table 2. Similarly, the thickness of the object-side surface 162 of the sixth lens 160 disclosed in Table 1 may not match the center thickness of the sixth lens 160 disclosed in Table 2.

In the optical system 100 according to the embodiment of the present invention, the first lens 110, the second lens 120, the third lens 130, the fourth lens 140, and the fifth lens 150 may be referred to as a first lens group G1, and the sixth lens 160 may be referred to as a second lens group G2. The lenses included in the first lens group G1 have a circular symmetrical shape, and the lens included in the second lens group G2 have a circular asymmetrical shape. The composite power of the first lens group G1 is positive, and the composite power of the second lens group G2 is negative. Accordingly, the first lens group G1 may serve to collect incident light and correct chromatic aberration, and the second lens group G2 may serve to disperse the incident light so that the incident light uniformly reaches the peripheral pixels of the image sensor. In the embodiment of the present invention, the second lens group includes the sixth lens 160 having a circular asymmetrical shape. When the sixth lens 160 has a circular asymmetrical shape, although the sixth lens 160 is a single lens, an effect in that a plurality of lenses overlap each other may be acquired.

According to the embodiment of the present invention, the first lens 110 may have the greatest center thickness among the first to sixth lenses. According to the embodiment of the present invention, the sum of a center thickness CT2 of the second lens 120 and a center thickness CT3 of the third lens 130 may be smaller than a center thickness CT1 of the first lens 110. According to the embodiment of the present invention, a ratio of the center thickness CT1 of the first lens 110 to the center thickness CT2 of the second lens 120 may be greater than 2 times, or more preferably greater than 3 times. According to the embodiment of the present invention, a ratio of the center thickness CT1 of the first lens 110 to a center thickness CT4 of the fourth lens 140 may be greater than 1 time, preferably greater than 2 times, or more preferably greater than 3 times. According to the embodiment of the present invention, the sum of the center thickness CT2 of the second lens 120 and the center thickness CT4 of the fourth lens 140 may be smaller than the center thickness CT1 of the first lens 110. According to the embodiment of the present invention, the sum of the center thickness CT2 of the second lens 120 and a center thickness CT6 of the sixth lens 160 may be smaller than the center thickness CT1 of the first lens 110. According to the embodiment of the present invention, the sum of the center thickness CT4 of the fourth lens 140 and the center thickness CT6 of the sixth lens 160 may be smaller than the center thickness CT1 of the first lens 110. Thus, when the center thickness CT1 of the first lens 110 having the smallest effective diameter among the first to sixth lenses is the greatest among the first to sixth lenses, while the manufacturability of the first lens 110 is improved, light may be collected by the first lens without distortion even when the effective diameter of the object-side surface 112 of the first lens 110 is sufficiently small, and the first lens may serve to collect light and correct chromatic aberration.

According to the embodiment of the present invention, the center thickness CT1 of the first lens 110 may be 0.2 times or more and 0.35 times or less, preferably 0.25 times or more and 0.33 times or less, and more preferably 0.27 times or more and 0.31 times or less the sum of the center thicknesses CT_16 of the first lens 110 to the sixth lens 160. According to the embodiment of the present invention, the center thickness CT1 of the first lens 110 may be 0.55 mm or more, preferably 0.6 mm or more, and more preferably 0.63 mm or more. Accordingly, while the manufacturability of the first lens 110 is improved, light may be collected by the first lens without distortion even when the effective diameter of the object-side surface 112 of the first lens 110 is sufficiently small, and the first lens may serve to collect light and correct chromatic aberration.

According to the embodiment of the present invention, the center thickness CT1 of the first lens 110 may be 0.1 times or more and 0.2 times or less, preferably 0.12 times or more and 0.18 times or less, more preferably 0.13 times or more and 0.17 times or less, and even more preferably 0.14 times or more and 0.16 times or less TTL which is a distance from the object-side surface 112 of the first lens 110 to the image sensor 180. Accordingly, while the manufacturability of the first lens 110 is improved, light may be collected by the first lens without distortion even when the effective diameter of the object-side surface 112 of the first lens 110 is sufficiently small, and the first lens may serve to collect light and correct chromatic aberration.

When the center thickness CT1 of the first lens 110 satisfies the above conditions, it is possible to manufacture a small-head lens whose diameter including a barrel is 2.15 mm or less. That is, according to the embodiment of the present invention, in order to minimize the head size of the optical system 100, the diameter of the effective region of the first lens 110 may be implemented as the smallest diameter among the diameters of the effective regions of the first lens 110 to the sixth lens 160. For example, according to the embodiment of the present invention, the diameter of the effective region of the first lens 110 may be designed to be 1.58 mm. When the center thickness CT1 of the first lens 110 satisfies the above conditions, it is possible to manufacture the first lens 110 satisfying the design of the diameter of the effective region of the first lens 110.

A distance between the first lens group G1 and the second lens group G2 of the present invention, that is, a distance T56 between the image-side surface 154 of the fifth lens 150 and the object-side surface 162 of the sixth lens 160 may be greater than a distance between neighboring lenses in the first lens group G1, for example, at least one of a distance T12 between the image-side surface 114 of the first lens 110 and the object-side surface 122 of the second lens 120, a distance T23 between the image-side surface 124 of the second lens 120 and the object-side surface 132 of the third lens 130, a distance T34 between the image-side surface 134 of the third lens 130 and the object-side surface 142 of the fourth lens 140, and a distance T45 between the image-side surface 144 of the fourth lens 140 and the object-side surface 152 of the fifth lens 150. The distance between the first lens group G1 and the second lens group G2 of the present invention, that is, the distance T56 between the image-side surface 154 of the fifth lens 150 and the object-side surface 162 of the sixth lens 160 may be greater than the distance T12 between the image-side surface 114 of the first lens 110 and the object-side surface 122 of the second lens 120, and may be greater than the distance T23 between the image-side surface 124 of the second lens 120 and the object-side surface 132 of the third lens 130. The distance between the first lens group G1 and the second lens group G2 of the present invention, that is, the distance T56 between the image-side surface 154 of the fifth lens 150 and the object-side surface 162 of the sixth lens 160 may be greater than the distance T34 between the image-side surface 134 of the third lens 130 and the object-side surface 142 of the fourth lens 140, or may be 0.95 to 1.1 times, preferably 0.97 to 1.07 times, and more preferably 0.99 to 1.05 times the distance T34 between the image-side surface 134 of the third lens 130 and the object-side surface 142 of the fourth lens 140. The distance between the first lens group G1 and the second lens group G2 of the present invention, that is, the distance T56 between the image-side surface 154 of the fifth lens 150 and the object-side surface 162 of the sixth lens 160 may be greater than the distance T45 between the image-side surface 144 of the fourth lens 140 and the object-side surface 152 of the fifth lens 150, or may be 0.95 to 1.1 times, preferably 0.97 to 1.07 times, and more preferably 0.99 to 1.05 times the distance T45 between the image-side surface 144 of the fourth lens 140 and the object-side surface 152 of the fifth lens 150. When the distance between the first lens group G1 and the second lens group G2 of the present invention, that is, the distance T56 between the image-side surface 154 of the fifth lens 150 and the object-side surface 162 of the sixth lens 160 satisfies the above conditions, light passing through the first lens group G1 may uniformly spread through the second lens group G2 and uniformly reach each peripheral pixel of the image sensor 180.

When at least one of the power of the first to sixth lens, a shape of a lens surface, the center thickness of the lens, and the distance between the lenses satisfies the above conditions, the first lens group G1 may serve to collect light and correct chromatic aberration, and the second lens group G2 may serve to uniformly spread light to each peripheral pixel of the image sensor. That is, according to the embodiment of the present invention, the effective diameter of the object-side surface 112 of the first lens 110 is designed to be smaller than the image sensor 180 in order to reduce the head size of the optical system 100. To be precise, the effective diameter of the object-side surface 112 of the first lens 110 is designed to be smaller than the image sensor 180, and when the distances between the lenses in the first lens group G1 satisfy the above conditions, light may be collected without distortion even when the effective diameter of the object-side surface 112 of the first lens 110 is sufficiently small. Further, when the distance between the first lens group G1 and the second lens group G2 satisfies the above conditions, that is, when disposed farther than the distances between the lenses in the first lens group G1, light collected by the first lens group G1 may pass through the second lens group G2 and uniformly reach each pixel of the image sensor 170 without distortion.

According to the embodiment of the present invention, the first lens 110, the second lens 120, the third lens 130, the fourth lens 140, and the fifth lens 150 have positive composite power, and the sixth lens 160 has negative power. That is, the composite power of the first lens 110, the second lens 120, the third lens 130, the fourth lens 140, and the fifth lens 150 may be 0.46, and the power of the sixth lens 160 may be −0.62. Accordingly, the first lens 110, the second lens 120, the third lens 130, the fourth lens 140, and the fifth lens 150 may serve to collect light incident on the object-side surface of the first lens 110, and the sixth lens 160 may serve to spread the light from the object-side surface 142 of the fourth lens 140 to the image-side surface 154 of the fifth lens 1550 so that the light reaches each pixel of the image sensor 180.

Specifically, as in the embodiment of the present invention, when the first lens 110 has positive power, the second lens 120 has negative power, an absolute value of power P1 of the first lens 110 is 1.5 times or more, preferably 1.7 times or more, and more preferably 2 times or more an absolute value of power P2 of the second lens 120, and the center thickness CT1 of the first lens 110 is 3 times or more the center thickness CT2 of the second lens, the first lens 110 may collect light incident on the optical system 100, and the second lens 120 may correct chromatic aberration.

Further, when the distance T56 between the first lens group G1 and the second lens group G2 is the greatest among the distances between neighboring lenses in the optical system 100, the second lens group G2 may serve to spread light more uniformly to the periphery of the image sensor.

According to the embodiment of the present invention, a total track length (TTL), which is a distance from the object-side surface 112 of the first lens 110 to the image sensor 180, is 3 mm to 6.5 mm, preferably 3 mm to 5.5 mm, and more preferably 4 mm to 4.5 mm, a distance from the object-side surface 122 of the second lens 120 to the image sensor 180 is 3.4618 mm, a distance from the object-side surface 132 of the third lens 130 to the image sensor 180 is 3.2048 mm, a distance from the object-side surface 142 of the fourth lens 140 to the image sensor 180 is 2.5666 mm, a distance from the object-side surface 152 of the fifth lens 150 to the image sensor 180 is 2.0563 mm, and a distance from the object-side surface 162 of the sixth lens 160 to the image sensor 180 is 1.2755 mm. Here, a back focal length (BFL), which is a distance from the image-side surface 164 of the sixth lens 160 to the image sensor 180 is 0.8775 mm. Further, a diagonal length (2*H_{imageD}) of the image sensor 180 is 6.53801 mm. From the point of view of those skilled in the art, the BFL should be implemented at 0.6 mm or more in consideration of manufacturability and assemblability. For example, in the case of a camera device having an autofocusing function, the BFL should be implemented at 0.7 mm or more for the assembly of the optical system and the image sensor, and when the optical system includes a circular asymmetrical lens, the BFL should be implemented at 0.7 mm or more. Since the optical system of the present invention includes a circular asymmetrical lens, the BFL should be implemented at 0.7 mm or more. Accordingly, the optical system 100 may be implemented in a compact size and may be built into a front side as well as a rear side of a mobile terminal.

According to the embodiment of the present invention, the effective diameter may gradually increase from the first lens 110 to the sixth lens 160. Here, the effective diameter may mean a diameter of an effective region of the object-side surface or the image-side surface on which light is incident.

In this case, an effective diameter (ED_{L6S2}) of the image-side surface 164 of the sixth lens 160 may be 2 times or more, preferably 2.5 times or more, and more preferably 3 times or more the effective diameter (ED_{L1S1}) of the object-side surface 112 of the first lens 110.

The effective diameter (ED_{L6S2}) of the image-side surface 164 of the sixth lens 160 may be 1.2 times or more, preferably 1.25 times or more, and more preferably 1.3 times or more an effective diameter (ED_{L5S2}) of the image-side surface 154 of the fifth lens 150. The effective diameter (ED_{L6S2}) of the image-side surface 164 of the sixth lens 160 may be smaller than the diagonal length (2*H_{imageD}) of the image sensor 180.

Accordingly, light is uniformly dispersed from the first lens to the sixth lens, and the amount of light which reaches the periphery of the image sensor 180 may be increased.

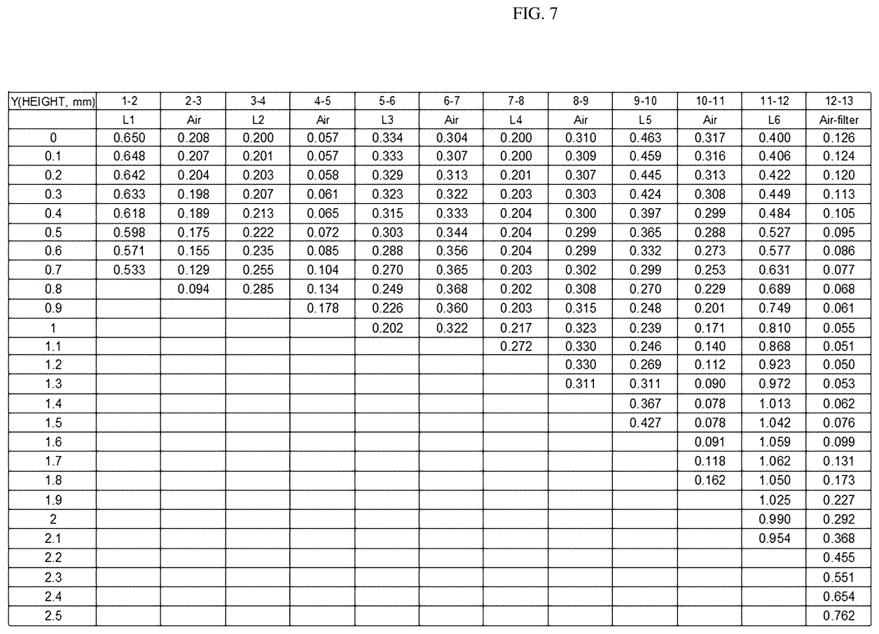

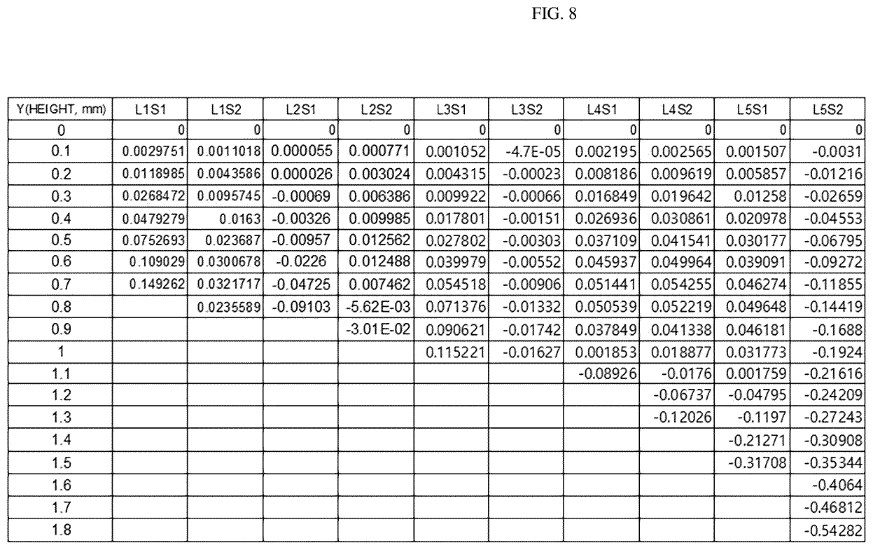

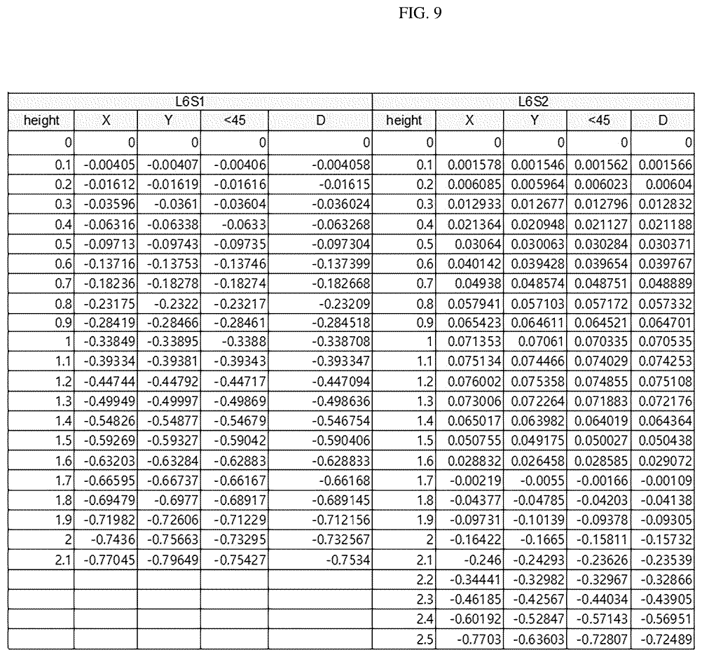

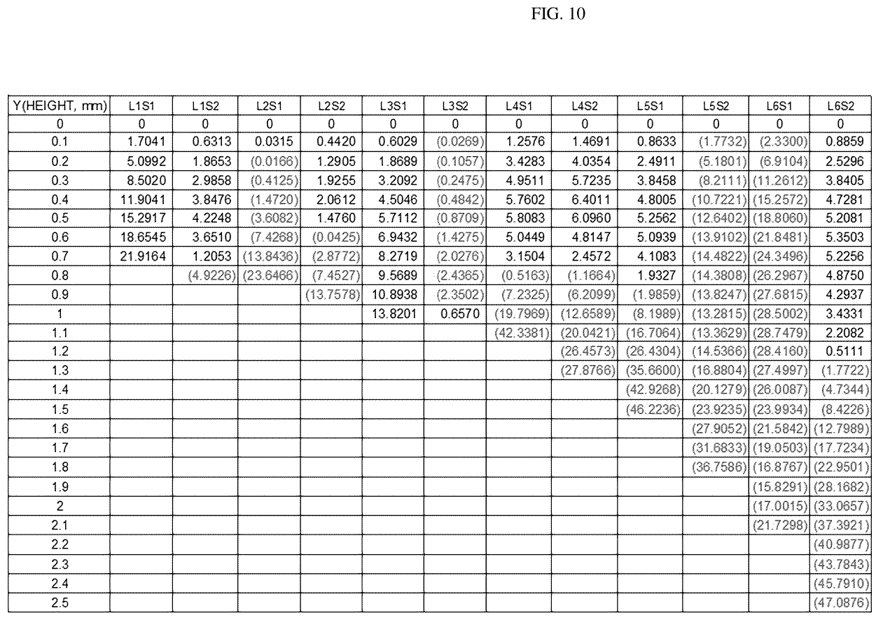

FIG. 7 is design data showing distances between lens surfaces according to a distance in a Y direction from the optical axis in the optical system according to the embodiment of the present invention, FIG. 8 is design data showing sag values of lens surfaces according to a distance in the Y direction from the optical axis in the first to fifth lenses of the optical system according to the embodiment of the present invention, FIG. 9 is design data showing sag values of lens surfaces according to a distance in the X direction, the Y direction, a diagonal direction, and a 45-degree direction from the optical axis in the sixth lens of the optical system according to the embodiment of the present invention, and FIG. 10 is design data showing tilt angles of lens surfaces according to a distance in the Y direction from the optical axis in the optical system according to the embodiment of the present invention. In FIGS. 7 to 10, L1, L2, L3, L4, L5, and L6 respectively represent the first lens 110, the second lens 120, the third lens 130, the fourth lens 140, the fifth lens 150, and the sixth lens 160, and L1S1, L1S2, L2S1, L2S2, L3S1, L3S2, L4S1, L4S2, L5S1, L5S2, L6S1, and L6S2 respectively represent the object-side surface 112 and the image-side surface 114 of the first lens 110, the object-side surface 122 and the image-side surface 124 of the second lens 120, the object-side surface 132 and the image-side surface 134 of the third lens 130, the object-side surface 142 and the image-side surface 144 of the fourth lens 140, the object-side surface 152 and the image-side surface 154 of the fifth lens 150, and the object-side surface 162 and the image-side surface 164 of the sixth lens 160. Air between L1 and L2 represents the distance between the first lens 110 and the second lens 120, air between L2 and L3 represents the distance between the second lens 120 and the third lens 130, air between L3 and L4 represents the distance between the third lens 130 and the fourth lens 140, air between L4 and L5 represents the distance between the fourth lens 140 and the fifth lens 150, and air between L5 and L6 represents the distance between the fifth lens 150 and the sixth lens 160.

Referring to FIG. 7, the distance between the image-side surface 114 of the first lens 110 and the object-side surface 122 of the second lens 120 may be uniformly maintained from the optical axis to an end of the image-side surface 114 of the first lens 110. Here, the end of the surface of the lens may mean an end of an effective region of the surface of the lens. Here, the optical axis may mean a point where a distance in the Y direction is 0. Here, when a ratio of a maximum distance to a minimum distance between the facing surfaces of different lenses from the optical axis to the end of the surface of the lens is 3 times or less, it may be interpreted as that the distance between the facing surfaces of different lenses is uniformly maintained.

That is, a ratio of a maximum distance (T12ₘₐₓ) to a minimum distance (T12ₘᵢₙ) between the image-side surface 114 of the first lens 110 and the object-side surface 122 of the second lens 120 from the optical axis to the end of the image-side surface 114 of the first lens 110 may be 3 times or less. In this case, the distance between the image-side surface 114 of the first lens 110 and the object-side surface 122 of the second lens 120 may tend to gradually decrease from the optical axis to the end of the image-side surface 114 of the first lens 110.

On the other hand, the distance between the image-side surface 124 of the second lens 120 and the object-side surface 132 of the third lens 130 may not be uniformly maintained from the optical axis to an end of the image-side surface 124 of the second lens 120. That is, a ratio of a maximum distance (T23ₘₐₓ) to a minimum distance (T23ₘᵢₙ) between the image-side surface 124 of the second lens 120 and the object-side surface 132 of the third lens 130 from the optical axis to the end of the image-side surface 124 of the second lens 120 may exceed 3 times. In this case, the distance between the image-side surface 124 of the second lens 120 and the object-side surface 132 of the third lens 130 tends to gradually increase from the optical axis to the end of the image-side surface 124 of the second lens 120. When the distances between the first lens 110, the second lens 120, and the third lens 130 have the above trend, light may be collected from the first lens 110 to the object-side surface 132 of the third lens 130.

Meanwhile, the distance between the image-side surface 134 of the third lens 130 and the object-side surface 142 of the fourth lens 140 may be uniformly maintained from the optical axis to the end of the image-side surface 134 of the third lens 130. That is, a ratio of a maximum distance (T34ₘₐₓ) to a minimum distance (T34ₘᵢₙ) between the image-side surface 134 of the third lens 130 and the object-side surface 142 of the fourth lens 140 from the optical axis to the end of the image-side surface 134 of the third lens 130 may be 3 times or less, preferably 2 times or less, and more preferably 1.5 times or less.

Similarly, the distance between the image-side surface 144 of the fourth lens 140 and the object-side surface 152 of the fifth lens 150 may be uniformly maintained from the optical axis to an end of the image-side surface 144 of the fourth lens 140. That is, a ratio of a maximum distance (T45ₘₐₓ) to a minimum distance (T45ₘᵢₙ) between the image-side surface 144 of the fourth lens 140 and the object-side surface 152 of the fifth lens 150 from the optical axis to the end of the image-side surface 144 of the fourth lens 140 may be 3 times or less, preferably 2 times or less, more preferably 1.5 times or less, and even more preferably 1.3 times or less.

On the other hand, the distance between the image-side surface 154 of the fifth lens 150 and the object-side surface 162 of the sixth lens 160 may not be uniformly maintained from the optical axis to an end of the image-side surface 154 of the fifth lens 150. That is, a ratio of a maximum distance (T56ₘₐₓ) to a minimum distance (T56ₘᵢₙ) between the image-side surface 154 of the sixth lens 150 and the object-side surface 162 of the sixth lens 160 from the optical axis to the end of the image-side surface 154 of the fifth lens 150 may exceed 3 times. In this case, the distance between the image-side surface 154 of the fifth lens 150 and the object-side surface 162 of the sixth lens 160 may tend to gradually decrease from the optical axis to an end of the effective region of the image-side surface 154 of the fifth lens 150. When the distance between the fifth lens 150 and the sixth lens 160 has the above trend, light emitted from the image-side surface 154 of the fifth lens 150 and incident on the object-side surface 162 of the sixth lens 160 may be uniformly dispersed on the object-side surface 162 of the sixth lens 160.

Meanwhile, referring to FIG. 7, among the first to sixth lenses forming the optical system 100 according to the embodiment of the present invention, the thickness at the end of the effective region is the greatest in the sixth lens 160 and second greatest in the first lens 110. Further, a thickness ST1 of the end of the effective region the first lens 110 may be 0.7 to 0.95 times, preferably 0.75 to 0.9 times, and more preferably 0.8 to 0.85 times the center thickness CT1 of the first lens 110. Accordingly, it is easy to manufacture the first lens 110 with a small effective diameter to minimize the head size.

Meanwhile, referring to FIGS. 8 to 10, according to the embodiment of the present invention, at least one surface of at least one of the first to sixth lenses forming the optical system 100 includes a critical point. The critical point may mean a point where the trend of the sag value changes. The sag value means a distance on the optical axis between any point on the lens surface and a point on the optical axis. The point where the trend of the sag value changes may be a point where the sag value increases and then decreases, or a point where the sag value decreases and then increases. The critical point may mean a point where the tilt angle becomes 0. The tilt angle may be defined as an angle formed by the normal to the tangent of the lens surface and the optical axis.

According to the embodiment of the present invention, at least one of the six surfaces of the first lens 110, the second lens 120, and the third lens 130 includes a critical point. For example, according to the embodiment of the present invention, at least one of the image-side surface 114 of the first lens 110, the object-side surface 122 of the second lens 120, the image-side surface 124 of the second lens 120, and the image-side surface 134 of the third lens 130 includes a critical point. Light is more effectively refracted near the critical point. That is, light passing through a lens surface including the critical point may be more effectively refracted compared to light passing through a lens surface not including the critical point. Thus, when at least one of the six surfaces of the first lens 110, the second lens 120, and the third lens 130 includes the critical point, light incident through the effective diameter of the object-side surface 112 of the first lens 110 may be refracted in the widest possible range between the first to third lenses, the light may uniformly reach the peripheral pixels of the image sensor 180, and the performance of the optical system 100 may be enhanced even when the effective diameter of the object-side surface 112 of the first lens 110 is designed to be small to minimize the head size.

Further, according to the embodiment of the present invention, at least two of the six surfaces of the fourth lens 140, the fifth lens 150, and the sixth lens 160 include critical points. In this case, at least one of the image-side surface 154 of the fifth lens 150 and the object-side surface 162 of the sixth lens 160 may not include the critical point, and the image-side surface 164 of the sixth lens 160 may include the critical point. Light is more effectively refracted near the critical point. When the critical point is present on the periphery of the image-side surface 164 of the sixth lens 160, which is the lens surface closest to the image sensor 180, it may be easy for the light refracted at the periphery of the image-side surface 164 of the sixth lens 160 to uniformly reach the peripheral pixels of the image sensor 180. The periphery may be a region closer to the effective diameter region than the optical axis. Specifically, when the critical point is present on the image-side surface 164 of the sixth lens 160, which is the lens surface closest to the image sensor 180, the manufacturability and assemblability of the optical system 100 may be improved compared to when the critical point is present on the image-side surface or object-side surface of the first lens 110, which is the lens surface farthest from the image sensor 180. Even when the sixth lens 160 is slightly tilted during assembly, since the assembly of the first to fifth lenses of the optical system 100 is not affected and thus optical performance is not significantly affected, the assemblability of the optical system 100 may be improved.

More specifically, according to the embodiment of the present invention, the critical point of the image-side surface 114 of the first lens 110 may be a point having a vertical distance of 0.6 mm to 0.8 mm, preferably 0.7 mm to 0.8 mm, from the optical axis. For example, when the optical axis is a starting point and the end of the image-side surface 114 of the first lens 110 is an end point, the critical point of the image-side surface 114 of the first lens 110 may be disposed at a position which is 80% to 100%, preferably 85% to 95%, and more preferably 87% to 92%. Here, the end of the surface of the lens may mean the end of the effective region of the surface of the lens, and the position of the critical point may be a position set based on a direction perpendicular to the optical axis.

According to the embodiment of the present invention, the critical point of the object-side surface 122 of the second lens 120 may be a point having a vertical distance of 0.3 mm, preferably 0.1 mm to 0.2 mm, from the optical axis. For example, when the optical axis is a starting point and the end of the object-side surface 122 of the second lens 120 is an end point, the critical point of the object-side surface 122 of the second lens 120 may be disposed at a position which is 5% to 30%, preferably 10% to 25%.

According to the embodiment of the present invention, the critical points of the image-side surface 114 of the first lens 110 and the object-side surface 122 of the second lens 120, which are surfaces facing each other, may be disposed in regions that do not face each other. That is, the critical point of the image-side surface 114 of the first lens 110 is disposed near an edge of the effective region of the image-side surface 114 of the first lens 110, and the critical point of the object-side surface 122 of the second lens 120 is disposed near the optical axis of the object-side surface 122 of the second lens 120. Accordingly, since light is refracted near each of the critical points of the image-side surface 114 of the first lens 110 and the critical point of the object-side surface 122 of the second lens 120, light at different distances from the optical axis may be uniformly refracted.

According to the embodiment of the present invention, the critical point of the image-side surface 124 of the second lens 120 may be a point having a vertical distance of 0.4 mm to 0.7 mm, preferably 0.5 mm to 0.6, mm from the optical axis. For example, when the optical axis is a starting point and the end of the image-side surface 124 of the second lens 120 is an end point, the critical point of the image-side surface 124 of the second lens 120 may be disposed at a position which is 40% to 70%, preferably 45% to 65%.

According to the embodiment of the present invention, the critical point of the image-side surface 134 of the third lens 130 may be a point having a vertical distance of 0.8 mm to 1.1 mm, preferably 0.9 mm to 1.0 mm, from the optical axis. For example, when the optical axis is a starting point and the end of the image-side surface 134 of the third lens 130 is an end point, the critical point of the image-side surface 134 of the third lens 130 may be disposed at a position which is 75% to 100%, preferably 80% to 95%.

Thus, when the critical point is present on at least one of the six surfaces of the first to third lenses, for example, on four surfaces, light may be uniformly dispersed in the first to third lenses, output through the image-side surface 134 of the third lens 130, and incident on the object-side surface 142 of the fourth lens 140.

According to the embodiment of the present invention, the object-side surface 142 of the fourth lens 140, the image-side surface 144 of the fourth lens 140, and the object-side surface 152 of the fifth lens 150 consecutively include critical points, and all of the critical points of the object-side surface 142 of the fourth lens 140, the image-side surface 144 of the fourth lens 140, and the object-side surface 152 of the fifth lens 150 may be disposed at points having a vertical distance of 0.6 mm to 0.9 mm, preferably 0.7 mm to 0.9 mm, from the optical axis. A ratio of the distance between the optical axis and the critical point of the image-side surface 144 of the fourth lens 140 to the distance between the optical axis and the critical point of the object-side surface 142 of the fourth lens 140 may be 0.9 to 1.1 times, preferably 0.95 to 1.05 times, and more preferably 0.97 to 1.03 times, and a ratio of the distance between the optical axis and the critical point of the object-side surface 152 of the fifth lens 150 to the distance between the optical axis and the critical point of the object-side surface 142 of the fourth lens 140 may be 0.9 to 1.3 times, preferably 1 to 1.3 times. When the above conditions are satisfied, light which is uniformly dispersed through the first to third lenses, output through the image-side surface 134 of the third lens 130, and then incident on the object-side surface 142 of the fourth lens 140 may be uniformly dispersed and incident from the centers to the peripheries of the fourth and fifth lenses.

According to the embodiment of the present invention, the image-side surface 154 of the fifth lens 150 and the object-side surface 162 of the sixth lens 160 do not include critical points, the image-side surface 154 of the fifth lens 150 is convex toward the image side, and the object-side surface 162 of the sixth lens 160 is concave toward the object side. Further, an absolute value of a radius of curvature (R_{L5S2}) of the image-side surface 154 of the fifth lens 150 may be 0.9 to 1.1 times, preferably 0.95 to 1.1 times, an absolute value of a radius of curvature (R_{L6S1}) of the object-side surface 162 of the sixth lens 160. When the image-side surface 154 of the fifth lens 150 and the object-side surface 162 of the sixth lens 160 satisfy the above conditions, light which is uniformly dispersed in the first to fifth lenses, output through the image-side surface 154 of the fifth lens 150, and then incident on the object-side surface 162 of the sixth lens 160 may be uniformly dispersed and output from the center to the periphery of the image-side surface 164 of the sixth lens 160.

In this case, the distance between the image-side surface 154 of the fifth lens 150 and the object-side surface 162 of the sixth lens 160 may tend to gradually decrease as it gets farther away from the optical axis. For example, the distance between the image-side surface 154 of the fifth lens 150 and the object-side surface 162 of the sixth lens 160 may decrease to a vertical distance corresponding to the critical point of the image-side surface 164 of the sixth lens 160 from the optical axis.

According to the embodiment of the present invention, a maximum tilt angle of each of the object-side surface 142 and the image-side surface 144 of the fourth lens 140, the object-side surface 152 and the image-side surface 154 of the fifth lens 150, and the object-side surface 162 of the sixth lens 160 at a vertical distance corresponding to the critical point in the Y-axis direction of the image-side surface 164 of the sixth lens 160 from the optical axis or more may be 25 degrees or more. Accordingly, the assemblability and manufacturability of the optical system may be improved, and light may be uniformly dispersed and output from the center to the periphery of the object-side surface 162 of the sixth lens 160.

According to the embodiment of the present invention, the first to fifth lenses are circular symmetrical lenses, and the sixth lens 160 is a lens whose both surfaces have circular asymmetrical shapes.

Referring to FIG. 9, both the object-side surface 162 and the image-side surface 164 of the sixth lens 160 have circular asymmetrical shapes. When both the object-side surface 162 and the image-side surface 164 of the sixth lens 160 have circular asymmetrical shapes, light distortion may be minimized, and an optical angle may be implemented and the RI may be increased while reducing the total number of lenses included in the optical system 100. A circular asymmetrical shape may mean that shapes of the lens cross-sections are different in the X-axis and Y-axis directions centered on the optical axis, the shapes of the lens cross-sections are different in a third direction between the X-axis and Y-axis directions and the X-axis direction, or the shapes of the lens cross-sections are different in the third direction between the X-axis and Y-axis directions and the Y-axis direction. Here, the third direction may mean a diagonal direction of the image sensor or a 45-degree direction between the X-axis and the Y-axis. When an X-axis length and a Y-axis length of the image sensor are the same, the diagonal direction of the image sensor and the 45-degree direction between the X-axis and the Y-axis may be the same. When the X-axis length and Y-axis length of the image sensor are different, for example, when a ratio of the X-axis length and the Y-axis length of the image sensor is 4 to 3, an angle between the X-axis direction and the diagonal direction may be smaller than 45 degrees, and an angle between the Y-axis direction and the diagonal direction may be larger than 45 degrees. Here, the case in which the shapes are different may mean that tilt angles are different, sag values are different, or points where critical points appear are different if there are critical points. For example, the case in which the shapes in the X-axis direction and the Y-axis direction are different from each other may mean that a region where a tilt angle in the X-axis direction and a tilt angle in the Y-axis direction are different from each other for the same distance from the optical axis is present, or a region where the sag value in the X-axis direction and the sag value in the Y-axis direction are different from each other for the same distance from the optical axis is present. When the critical point is present, the case in which the shapes in the X-axis direction and the Y-axis direction are different from each other may mean that a distance between the optical axis and the critical point in the X-axis direction and a distance between the optical axis and the critical point in the Y-axis direction are different from each other. The circular asymmetrical shape may be used interchangeably with a free surface shape, an autonomous surface shape, a rotational asymmetric shape, a free-form shape, origin asymmetry, or the like.

According to the embodiment of the present invention, there is a deviation between a sag value in the X direction and a sag value in the Y direction at the object-side surface 162 of the sixth lens 160. According to the embodiment of the present invention, at least three of the sag value in the X direction, the sag value in the Y direction, a sag value in a direction formed at 45 degrees from the X-axis (hereinafter, a 45-degree direction), and a sag value in a diagonal direction of the image sensor 180 are different from each other at the object-side surface 162 of the sixth lens 160. According to the embodiment of the present invention, the sag value in the X direction, the sag value in the Y direction, the sag value in the direction formed at 45 degrees from the X-axis (hereinafter, the 45-degree direction), and the sag value in the diagonal direction of the image sensor 180 are different from each other at the object-side surface 162 of the sixth lens 160.

As described above, the sag value means a distance on the optical axis between any point on the lens surface and a point on the optical axis. In FIG. 9, a case in which the sag value is positive means a shape protruding to the right from the optical axis, and a case in which the sag value is negative means a shape protruding to the left from the optical axis. It is apparent to those skilled in the art that the sign of the sag value may be defined in reverse. For example, a case in which the sag value is negative may also mean a shape protruding to the right from the optical axis, and a case in which the sag value is positive may also mean a shape protruding to the left from the optical axis.

For example, a deviation between at least two of a sag value (Sag_{L6S1_X}) in the X direction, a sag value (Sag_{L6S1_Y}) in the Y direction, a sag value (Sag_{L6S1_45}) in the 45-degree direction, and a sag value (Sag_{L6S1_D}) in the diagonal direction of the image sensor may be 0.001 μm to 50 μm at the object-side surface 162 of the sixth lens 160. For example, the deviation between at least two of the sag value (Sag_{L6S1_X}) in the X direction, the sag value (Sag_{L6S1_Y}) in the Y direction, the sag value (Sag_{L6S1_45}) in the 45-degree direction, and the sag value (Sag_{L6S1_D}) in the diagonal direction of the image sensor may be greater in a second region having a second distance in a direction away from the optical axis from a first region than in the first region having a first distance from the optical axis at the object-side surface 162 of the sixth lens 160. Here, the second distance may be 50% or more, preferably 60% or more, and more preferably 70% or more of the effective region of the object-side surface 162 of the sixth lens 160. For example, in an embodiment in which the effective diameter of the object-side surface 162 of the sixth lens 160 is 4.362 mm, the deviation between at least two of the sag value (Sag_{L6S1_X}) in the X direction, the sag value (Sag_{L6S1_Y}) in the Y direction, the sag value (Sag_{L6S1_45}) in the 45-degree direction, and the sag value (Sag_{L6S1_D}) in the diagonal direction of the image sensor may be 2 μm or more, preferably 2 μm to 50 μm, in a region where the vertical distance from the optical axis is 1.09 mm or more, preferably 1.31 mm or more, more preferably 1.53 mm or more, and even more preferably 1.6 mm or more.

Accordingly, since the object-side surface 162 of the sixth lens 160 is a circular asymmetrical lens, a light dispersion effect which is the same level as when a plurality of lenses overlap may be acquired, and accordingly, light passing through the object-side surface 162 of the sixth lens 160 may be more uniformly dispersed and reach the peripheral pixels of the image sensor 180 even in a narrow space.

According to the embodiment of the present invention, there is a deviation between the sag value in the X direction and the sag value in the Y direction at the image-side surface 164 of the sixth lens 160. According to the embodiment of the present invention, at least three of the sag value in the X direction, the sag value in the Y direction, a sag value in a direction formed at 45 degrees from the X-axis (hereinafter, a 45-degree direction), and a sag value in a diagonal direction of the image sensor 180 are different from each other at the image-side surface 164 of the sixth lens 160. According to the embodiment of the present invention, the sag value in the X direction, the sag value in the Y direction, the sag value in the direction formed at 45 degrees from the X-axis (hereinafter, the 45-degree direction), and the sag value in the diagonal direction of the image sensor 180 are different from each other at the image-side surface 164 of the sixth lens 160.

For example, a deviation between at least two of a sag value (Sag_{L6S2_X}) in the X direction, a sag value (Sag_{L6S2_Y}) in the Y direction, a sag value (Sag_{L6S2_45}) in the 45-degree direction, and a sag value (Sag_{L6S2_D}) in the diagonal direction of the image sensor may be 0.001 μm to 200 μm at the image-side surface 164 of the sixth lens 160. For example, the deviation between at least two of the sag value (Sag_{L6S2_X}) in the X direction, the sag value (Sag_{L6S2_Y}) in the Y direction, the sag value (Sag_{L6S2_45}) in the 45-degree direction, and the sag value (Sag_{L6S2_D}) in the diagonal direction of the image sensor may be greater in a second region having a second distance in a direction away from the optical axis from a first region than in the first region having a first distance from the optical axis at the image-side surface 164 of the sixth lens 160. Here, the second distance may be 50% or more, preferably 55% or more, and more preferably 60% or more of the effective region of the image-side surface 164 of the sixth lens 160. For example, in an embodiment in which the effective diameter of the image-side surface 164 of the sixth lens 160 is 5.048 mm, the deviation between at least two of the sag value (Sag_{L6S2_X}) in the X direction, the sag value (Sag_{L6S2_Y}) in the Y direction, the sag value (Sag_{L6S2_45}) in the 45-degree direction, and the sag value (Sag_{L6S2_D}) in the diagonal direction of the image sensor may be 2 μm or more, preferably 2 μm to 200 μm, in a region where the vertical distance from the optical axis is 1.262 mm or more, preferably 1.388 mm or more, more preferably 1.51 mm or more, and even more preferably 1.6 mm or more.

Accordingly, since the image-side surface 164 of the sixth lens 160 is a circular asymmetrical lens, a light dispersion effect which is the same level as when a plurality of lenses overlap can be acquired, and accordingly, light passing through the image-side surface 164 of the sixth lens 160 may be more uniformly dispersed and reach the peripheral pixels of the image sensor 180 even in a narrow space.

According to the embodiment of the present invention, the image-side surface 164 of the sixth lens 160 may have a critical point.

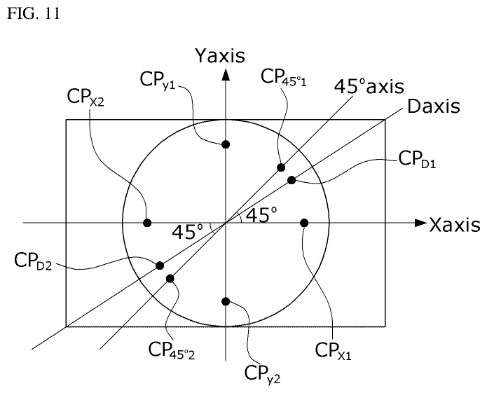

FIG. 11 shows the image-side surface of the sixth lens and the image sensor of the optical system according to one embodiment of the present invention.

Referring to FIG. 11, a distance between a critical point of the X-axis of the image-side surface 164 of the sixth lens 160 and the optical axis may be 0.9 to 1.1 times, preferably 0.95 to 1.05 times, and more preferably 0.97 to 1.03 times a distance between a critical point of the Y-axis of the image-side surface 164 of the sixth lens 160 and the optical axis. The distance between the critical point of the X-axis of the image-side surface 164 of the sixth lens 160 and the optical axis may be 0.9 to 1.1 times, preferably, 0.95 to 1.05 times, and more preferably, 0.97 to 1.03 times a distance between a critical point in the 45-degree direction of the image-side surface 164 of the sixth lens 160 and the optical axis. The distance between the critical point of the X-axis of the image-side surface 164 of the sixth lens 160 and the optical axis may be 0.9 to 1.1 times, preferably, 0.95 to 1.05 times, and more preferably, 0.97 to 1.03 times a distance between a critical point in the diagonal direction of the image-side surface 164 of the sixth lens 160 and the optical axis. For example, the critical point of the X-axis, the critical point of the Y-axis, the critical point in the 45-degree direction, and the critical point in the diagonal direction of the image-side surface 164 of the sixth lens 160 may all be points having vertical distances of 1.1 mm to 1.4 mm, preferably 1.2 mm to 1.3 mm, from the optical axis. For example, the critical point of the X-axis, the critical point of the Y-axis, the critical point in the 45-degree direction, and the critical point in the diagonal direction of the image-side surface 164 of the sixth lens 160 may all be points which are 40 to 60%, preferably 44 to 56%, and more preferably 48 to 52% of the effective region based on the optical axis. Thus, when the critical point is present on the image-side surface 164 of the sixth lens 160, the dispersion characteristics of light passing through the image-side surface 164 of the sixth lens 160 may be maximized.

According to the embodiment of the present invention, at least three of a sag value of the critical point in the X direction, a sag value of the critical point in the Y direction, a sag value of the critical point in the direction formed at 45 degrees from the X-axis (hereinafter, the 45-degree direction), and a sag value of the critical point in the diagonal direction of the image sensor 180 are different from each other at the image-side surface 164 of the sixth lens 160. According to the embodiment of the present invention, the sag value in the X direction, the sag value in the Y direction, the sag value in the direction formed at 45 degrees from the X-axis (hereinafter, the 45-degree direction), and the sag value in the diagonal direction of the image sensor 180 are different from each other at the image-side surface 164 of the sixth lens 160. Accordingly, since the image-side surface 164 of the sixth lens 160 has a circular asymmetrical shape and thus an effect of a plurality of lenses can be acquired using a single lens, efficient light dispersion may be expected in a narrow space, and light may uniformly reach the peripheral pixels of the image sensor 180.

Referring to FIG. 9, a deviation between the sag value of the critical point of the X-axis and the sag value of the critical point in the 45-degree direction may be greater than a deviation between the sag value of the critical point of the X-axis and the sag value of the critical point of the Y-axis of the image-side surface 164 of the sixth lens 160. For example, the deviation between the sag value of the critical point of the X-axis and the sag value of the critical point of the Y-axis of the image-side surface 164 of the sixth lens 160 may be 0.001 μm or more and 1 μm or less, whereas the deviation between the sag value of the critical point of the X-axis and the sag value of the critical point in the 45-degree direction may exceed 1 μm. Alternatively, among an absolute value of the sag value of the critical point of the X-axis, an absolute value of the sag value of the critical point of the Y-axis, and an absolute value of the sag value of the critical point in the 45-degree direction of the image-side surface 164 of the sixth lens 160, the absolute value of the sag value of the critical point in the 45-degree direction may be the smallest. Thus, when the sag values are different from each other at the critical point of the X-axis, the critical point of the Y-axis, the critical point in the 45-degree direction, and the critical point in the diagonal direction of the image-side surface 164 of the sixth lens 160, since the image-side surface 164 of the sixth lens 160 has a circular asymmetrical shape and thus an effect of a plurality of lenses can be acquired using a single lens, efficient light dispersion may be expected in a narrow space, and light may uniformly reach the peripheral pixels of the image sensor 180.

According to the embodiment of the present invention, the maximum tilt angle at the image-side surface 164 of the sixth lens 160 may be disposed from the critical point to an edge. According to the embodiment of the present invention, the maximum tilt angle from the critical point to the edge of the image-side surface 164 of the sixth lens 160 may be 5 to 10 times, preferably 7 to 10 times, the maximum tilt angle between the optical axis and the critical point. In this case, the maximum tilt angle may be 65 degrees or less within a range of 60 to 90% of the effective diameter of the image-side surface 164 of the sixth lens 160. Accordingly, manufacturing performance may be improved while satisfying optical performance.

Accordingly, the dispersion characteristics of light passing through the image-side surface 164 of the sixth lens 160 may be maximized, and the RI may be improved.

The optical system 100 according to the embodiment of the present invention may satisfy at least one of the conditional equations described below. Accordingly, the optical system 100 according to the embodiment of the present invention may have an optically enhanced effect. Specifically, the optical system 100 according to the embodiment of the present invention may acquire optical performance in which the effective focal length (EFL) is 3.478 mm, the F number is 2.3 or less, the FOV in the diagonal direction is 85 degrees or more, and the RI is 30% or more in the 1 field under the condition that a half value (H_{imageD}) of a diagonal length of a pixel region of the image sensor 180 is 3.2690 mm.

0.15<ED_{L1S1}/2H_{imageD}<0.35 [Equation 1-1]

0.2<ED_{L1S1}/2H_{imageD}<0.3 [Equation 1-2]

0.22<ED_{L1S1}/2H_{imageD}<0.26 [Equation 1-3]

Here, H_{imageD} is a half value of the diagonal length of the pixel region of the image sensor 180. According to [Equation 1-1] to [Equation 1-3], since an area where the object-side surface 112 of the first lens 110 is exposed to the outside may be minimized within a range in which the first lens 110 can be manufactured, the head size of the optical system 100 may be minimized. When ED_{L1S1}/2H_{imageD} is smaller than the lower limits of the above numerical ranges, it may be difficult to manufacture the first lens 110, and when ED_{L1S1}/2H_{imageD} exceeds the upper limits, it may be difficult to implement an optical system with a small head size.

3 mm≤TTL≤6.5 mm [Equation 2-1]

3 mm≤TTL≤5.5 mm [Equation 2-2]

4 mm≤TTL≤4.5 mm [Equation 2-3]

Here, TTL is a distance from the object-side surface 112 of the first lens 110 to the image sensor 180. When the TTL is smaller than the lower limits of [Equation 2-1] to [Equation 2-3], manufacturability is poor and it may be difficult to achieve a preferable effective focal length, and when the TTL exceeds the upper limits of [Equation 2-1] to [Equation 2-3], the size of the camera device increases and thus it may be difficult to implement a camera device in a compact size in a mobile terminal.

0.9≤TTL/EFL≤1.5 [Equation 3-1]

1.0≤TTL/EFL≤1.5 [Equation 3-2]

1.1≤TTL/EFL≤1.3 [Equation 3-3]

Here, EFL is an effective focal length. According to [Equation 3-1] to [Equation 3-3], a high-resolution image may be acquired even in a narrow space. When TTL/EFL is smaller than the lower limits of the above numerical ranges, manufacturability is poor and it may be difficult to achieve a preferable effective focal length, and when TTL/EFL exceeds the upper limits of the above numerical ranges, the size of the camera device increases and thus it may be difficult to implement a camera device in a compact size in a mobile terminal.

0.5≤TTL/2*H_{imageD}≤0.9 [Equation 4-1]

0.55≤TTL/2*H_{imageD}≤0.8 [Equation 4-2]

0.61≤TTL/2*H_{imageD}≤0.69 [Equation 4-3]

According to [Equation 4-1] to [Equation 4-3], a high-resolution image may be acquired even in a narrow space. When TTL/2*H_{imageD} is smaller than the lower limits of the above numerical ranges, manufacturability is poor and it may be difficult to achieve a preferable effective focal length, and when TTL/2*H_{imageD} exceeds the upper limits of the above numerical ranges, the size of the camera device increases and thus it may be difficult to implement a camera device in a compact size in a mobile terminal.

2≤TTL/EPD≤3.5 [Equation 5-1]

2.5≤TTL/EPD≤3 [Equation 5-2]

2.65≤TTL/EPD≤2.85 [Equation 5-3]

According to [Equation 5-1] to [Equation 5-3], the head size of the optical system 100 and the overall size of the camera device may be miniaturized. When TTL/EPD is smaller than the lower limits of the above numerical ranges, manufacturability is poor and it may be difficult to achieve a preferable effective focal length, and when TTL/EPD exceeds the upper limits of the above numerical ranges, the size of the camera device increases and thus it may be difficult to implement a camera device in a compact size in a mobile terminal.

1.422≤ED_{L1S1}≤1.738 [Equation 6-1]

1.501≤ED_{L1S1}≤1.659 [Equation 6-2]

1.533≤ED_{L1S1}≤1.627 [Equation 6-3]

According to [Equation 6-1] to [Equation 6-3], the head size of the optical system 100 may be miniaturized. When ED_{L1S1} is smaller than the lower limits of the above numerical ranges, it may be difficult to manufacture the first lens 110, and when ED_{L1S1} exceeds the upper limits, it may be difficult to implement an optical system with a small head size.

CT1>CT2+CT3 [Equation 7]

Here, CT1 is a center thickness of the first lens 110, CT2 is a center thickness of the second lens 120, and CT3 is a center thickness of the third lens 130. Accordingly, light may be collected by the first to third lenses without distortion even when the effective diameter of the object-side surface 112 of the first lens 110 is sufficiently small, and the first to third lenses may serve to collect light and correct chromatic aberration.

CT1/CT2>2 [Equation 8-1]

CT1/CT2>3 [Equation 8-2]

According to [Equation 8-1] and [Equation 8-2], light may be collected by the first lens without distortion even when the effective diameter of the object-side surface 112 of the first lens 110 is sufficiently small, and the first lens may serve to collect light and correct chromatic aberration.

CT1>CT4 [Equation 9-1]

CT1/CT4>2 [Equation 9-2]

CT1/CT4>3 [Equation 9-3]

Here, CT4 is a center thickness of the fourth lens 140. Accordingly, light may be collected by the first lens without distortion even when the effective diameter of the object-side surface 112 of the first lens 110 is sufficiently small.

CT1>CT5 [Equation 10]

Here, CT5 is a center thickness of the fifth lens 150. Accordingly, light may be collected by the first lens without distortion even when the effective diameter of the object-side surface 112 of the first lens 110 is sufficiently small.

0.1<CT1/TTL<0.2 [Equation 11-1]

0.12<CT1/TTL<0.18 [Equation 11-2]

0.13<CT1/TTL<0.17 [Equation 11-3]

Accordingly, light may be collected by the first lens without distortion even when the effective diameter of the object-side surface 112 of the first lens 110 is sufficiently small, and the first lens may serve to collect light and correct chromatic aberration. When CT1/TTL is smaller than the lower limits of the above numerical ranges, the effect of collecting light and correcting chromatic aberration of the first lens may be lowered, and when CT1/TTL exceeds the upper limits of the above numerical ranges, the manufacturability and assemblability of the first lens may be lowered.

0.2<CT1/CT_16<0.35 [Equation 12-1]

0.25<CT1/CT_16<0.33 [Equation 12-2]

0.27<CT1/CT_16<0.31 [Equation 12-3]

Accordingly, light may be collected by the first lens without distortion even when the effective diameter of the object-side surface 112 of the first lens 110 is sufficiently small, and the first lens may serve to collect light and correct chromatic aberration. When CT1/CT_16 is smaller than the lower limits of the above numerical ranges, the effect of collecting light and correcting chromatic aberration of the first lens may be lowered, and when CT1/CT_16 exceeds the upper limits of the above numerical ranges, the manufacturability and assemblability of the first lens may be lowered.

1.5≤|P1|/|P2| [Equation 13-1]

1.7≤|P1|/|P2| [Equation 13-2]

2≤|P1|/|P2| [Equation 13-3]

Here, P1 is power of the first lens 110 and P2 is power of the second lens 120. Accordingly, the first lens 110 may collect light incident on the optical system 100 and the second lens 120 may correct chromatic aberration. When |P1|/|P2| is smaller than the lower limits of the above numerical ranges or exceeds the upper limits of the above numerical ranges, the effect of collecting light and correcting chromatic aberration of the first and second lenses may be lowered.

0.7≤BFL [Equation 14]

Here, BFL is a distance from the image-side surface 164 of the sixth lens 160 to the image sensor 180. Accordingly, even when the optical system 100 includes a circular asymmetrical lens, the assemblability is excellent. When the BFL is out of the above numerical ranges, the assemblability of the optical system 100 may be lowered.

ED_{L1S1}<ED_{L1S2}<ED_{L2S1}<ED_{L2S2}<ED_{L3S1}<ED_{L3S2}<ED_{L4S1}<ED_{L4S2}<ED_{L5S1}<ED_{L5S2}<ED_{L6S1}<ED_{L652}<2*H_{imageD} [Equation 15]

Here, ED_{LaS1} is an effective diameter of an object-side surface of an a-th lens and ED_{LaS2} is an effective diameter of an image-side surface of the a-th lens. Accordingly, as light is uniformly dispersed from the first lens 110 to the sixth lens 160, the amount of light which reaches the periphery of the image sensor 180 may be increased.

2≤ED_{L6S2}/ED_{L1S1} [Equation 16-1]

2.5≤ED_{L6S2}/ED_{L1S1} [Equation 16-2]

3≤ED_{L6S2}/ED_{L1S1} [Equation 16-3]

Accordingly, the first lens may serve to collect light incident on the optical system 100 and the sixth lens may serve to disperse light incident on the sixth lens to increase the amount of light which reaches the periphery of the image sensor 180. When ED_{L6S2}/ED_{L1S1} is out of the above numerical ranges, it may be difficult to manufacture the first lens or minimize the head size of the optical system.

1.2≤ED_{L6S2}/ED_{L5S2} [Equation 17-1]

1.25≤ED_{L6S2}/ED_{L5S2} [Equation 17-2]

1.3≤ED_{L6S2}/ED_{L5S2} [Equation 17-3]

Accordingly, the sixth lens may serve to disperse light incident on the sixth lens to increase the amount of light which reaches the periphery of the image sensor 180. When ED_{L6S2}/ED_{L5S2} is out of the above numerical ranges, it may be difficult to manufacture the first lens or minimize the head size of the optical system.

T12ₘₐₓ/T12ₘᵢₙ≤3 [Equation 18]

Here, T12ₘₐₓ is a maximum distance between the image-side surface 114 of the first lens 110 and the object-side surface 122 of the second lens 120, and T12ₘᵢₙ is a minimum distance between the image-side surface 114 of the first lens 110 and the object-side surface 122 of the second lens 120. Accordingly, light may reach the object-side surface 122 of the second lens 120 from the image-side surface 114 of the first lens 110 without spreading.

T23ₘₐₓ/T23ₘᵢₙ≤3 [Equation 19]

Here, T23ₘₐₓ is a maximum distance between the image-side surface 124 of the second lens 120 and the object-side surface 132 of the third lens 130, and T23ₘᵢₙ is a minimum distance between the image-side surface 124 of the second lens 120 and the object-side surface 132 of the third lens 130. Accordingly, light output from the image-side surface 124 of the second lens 120 may be uniformly dispersed and then may be incident on the object-side surface 132 of the third lens 130 from the optical axis to an end thereof.

T34ₘₐₓ/T34ₘᵢₙ≤3 [Equation 20-1]

T34ₘₐₓ/T34ₘᵢₙ≤2 [Equation 20-2]

T34ₘₐₓ/T34ₘᵢₙ≤1.5 [Equation 20-3]

Here, T34ₘₐₓ is a maximum distance between the image-side surface 134 of the third lens 130 and the object-side surface 142 of the fourth lens 140, and T34ₘᵢₙ is a minimum distance between the image-side surface 134 of the third lens 130 and the object-side surface 142 of the fourth lens 140. Accordingly, light may reach the object-side surface 142 of the fourth lens 140 from the image-side surface 134 of the third lens 130 in a concentrated state without being dispersed.

T45ₘₐₓ/T45ₘᵢₙ≤3 [Equation 21-1]

T45ₘₐₓ/T45ₘᵢₙ≤2 [Equation 21-2]

T45ₘₐₓ/T45ₘᵢₙ≤1.3 [Equation 21-3]

Here, T45ₘₐₓ is a maximum distance between the image-side surface 144 of the fourth lens 140 and the object-side surface 152 of the fifth lens 150, and T45ₘᵢₙ is a minimum distance between the image-side surface 144 of the fourth lens 140 and the object-side surface 152 of the fifth lens 150. Accordingly, light may reach the object-side surface 152 of the fifth lens 150 from the image-side surface 144 of the fourth lens 140 in a concentrated state without being dispersed.

T65ₘₐₓ/T65ₘᵢₙ>3 [Equation 22]

Here, T65ₘₐₓ is a maximum distance between the image-side surface 154 of the fifth lens 150 and the object-side surface 162 of the sixth lens 160, and T65ₘᵢₙ is a minimum distance between the image-side surface 154 of the fifth lens 150 and the object-side surface 162 of the sixth lens 160. Accordingly, light output from the image-side surface 154 of the fifth lens 150 may be uniformly dispersed and then may be incident on the object-side surface 162 of the sixth lens 160 from the optical axis to an end thereof.

0.7≤ST1/CT1≤0.95 [Equation 23-1]

0.75≤ST1/CT1≤0.9 [Equation 23-2]

0.8≤ST1/CT1≤0.85 [Equation 23-3]

Here, ST1 is a thickness of an end of the effective region of the first lens 110. Accordingly, it is easy to manufacture the first lens 110 with a small effective diameter to minimize the head size. When ST1/CT1 is smaller than the lower limits of the above numerical ranges, it may be difficult to manufacture the first lens and expect a high light-collecting effect of the first lens, and when ST1/CT1 exceeds the upper limits of the above numerical ranges, it may be difficult to manufacture the first lens.

0.9≤|R_{L5S2}/R_{L6S1}|≤1.1 [Equation 24-1]

0.95≤|R_{L5S2}/R_{L6S1}|≤1.1 [Equation 24-2]

Here, R_{L5S2} is a radius of curvature of the image-side surface 154 of the fifth lens 150, and R_{L6S1} is a radius of curvature of the object-side surface 162 of the sixth lens 160. Light which is uniformly dispersed in the first to fifth lenses, output through the image-side surface 154 of the fifth lens 150, and then incident on the object-side surface 162 of the sixth lens 160 may be uniformly dispersed and output from the center to the periphery of the image-side surface 164 of the sixth lens 160.

0.9≤D_CP_{L4S2}/D_CP_{L4S1}≤1.1 [Equation 25-1]

0.95≤D_CP_{L4S2}/D_CP_{L4S1}≤1.05 [Equation 25-2]

0.97≤D_CP_{L4S2}/D_CP_{L4S1}≤1.03 [Equation 25-3]

Here, D_CP_{L4S1} is a vertical distance between the critical point of the object-side surface 142 of the fourth lens 140 and the optical axis, and D_CP_{L4S2} is a vertical distance between the critical point of the image-side surface 144 of the fourth lens 140 and the optical axis. Accordingly, light which is uniformly dispersed through the first to third lenses, output through the image-side surface 134 of the third lens 130, and then incident on the object-side surface 142 of the fourth lens 140 may be uniformly dispersed and incident on the fourth and fifth lenses from the centers to the peripheries thereof.

0.9≤D_CP_{L5S1}/D_CP_{L4S1}≤1.3 [Equation 26-1]

1≤D_CP_{L5S1}/D_CP_{L4S1}≤1.3 [Equation 26-2]

Here, D_CP_{L5S1} is a vertical distance between the critical point of the object-side surface 152 of the fifth lens 150 and the optical axis. Accordingly, light which is uniformly dispersed through the first to third lenses, output through the image-side surface 134 of the third lens 130, and then incident on the object-side surface 142 of the fourth lens 140 may be uniformly dispersed and incident on the fourth and fifth lenses from the centers to the peripheries thereof.

0.001 μm≤|Sag_{L56S1_X}−Sag_{L56S1_Y}|≤50 μm [Equation 27]

Here, Sag_{L56S1_X} is a sag value in the X direction of the object-side surface 162 of the sixth lens 160, and Sag_{L56S1_Y} is a sag value in the Y direction of the object-side surface 162 of the sixth lens 160. Accordingly, light passing through the object-side surface 162 of the sixth lens 160 may be more uniformly dispersed and reach the peripheral pixels of the image sensor 180. When |Sag_{L56S1_X}−Sag_{L56S1_Y}| is smaller than the lower limit of the above numerical range, it may be difficult to expect an effect according to a circular asymmetrical shape, and when |Sag_{L56S1_X}−Sag_{L56S1_Y}| exceeds the upper limit of the above numerical range, the manufacturing, design, and performance prediction of the sixth lens may be difficult.

0.001 μm≤|Sag_{L6S1_X}−Sag_{L6S1_D}|≤50 μm [Equation 28]

Here, Sag_{L6S1_D} is a sag value in the diagonal direction of the object-side surface 162 of the sixth lens 160. Accordingly, light passing through the object-side surface 162 of the sixth lens 160 may be more uniformly dispersed and reach the peripheral pixels of the image sensor 180. When |Sag_{L6S1_X}−Sag_{L6S1_D}| is smaller than the lower limit of the above numerical range, it may be difficult to expect an effect according to a circular asymmetrical shape, and when |Sag_{L6S1_X}−Sag_{L6S1_D}| exceeds the upper limit of the above numerical range, the manufacturing, design, and performance prediction of the sixth lens may be difficult.

0.001 μm≤|Sag_{L6S1_X}−Sag_{L6S1_45}|≤50 μm [Equation 29]

Here, Sag_{L6S1_45} is a sag value in a direction formed at 45 degrees from the X direction of the object-side surface 162 of the sixth lens 160. Accordingly, light passing through the object-side surface 162 of the sixth lens 160 may be more uniformly dispersed and reach the peripheral pixels of the image sensor 180. When |Sag_{L6S1_X}−Sag_{L6S1_45}| is smaller than the lower limit of the above numerical range, it may be difficult to expect an effect according to a circular asymmetrical shape, and when |Sag_{L6S1_X}−Sag_{L6S1_45}| exceeds the upper limit of the above numerical range, the manufacturing, design, and performance prediction of the sixth lens may be difficult.

0.001 μm≤|Sag_{L6S2_X}−Sag_{L6S2_Y}|≤200 μm [Equation 30]

Here, Sag_{L6S2_X} is a sag value in the X direction of the image-side surface 164 of the sixth lens 160, and Sag_{L6S2_Y} is a sag value in the Y direction of the image-side surface 164 of the sixth lens 160. Accordingly, light passing through the object-side surface 162 of the sixth lens 160 may be more uniformly dispersed and reach the peripheral pixels of the image sensor 180. In addition, since an effect of a plurality of lenses being disposed in an overlapping manner can be acquired using a single sixth lens 160, optical performance may be increased while implementing the optical system 100 in a small size. When |Sag_{L6S2_X}−Sag_{L6S2_Y}| is smaller than the lower limit of the above numerical range, it may be difficult to expect an effect according to a circular asymmetrical shape, and when |Sag_{L6S2_X}−Sag_{L6S2_Y}| exceeds the upper limit of the above numerical range, the manufacturing, design, and performance prediction of the sixth lens may be difficult.

|CP_Sag_{L6S1_X}−CP_Sag_{L6S1_Y}|<|CP_Sag_{L6S1_X}−CP_Sag_{L6S1_45}| [Equation 31]

Here, CP_Sag_{L6S1_X} is a sag value of the critical point in the X direction of the object-side surface 162 of the sixth lens 160, CP_Sag_{L6S1_Y} is a sag value of the critical point in the Y direction of the object-side surface 162 of the sixth lens 160, and CP_Sag_{L6S1_D} is a sag value of the critical point in the 45-degree direction of the object-side surface 162 of the sixth lens 160. Accordingly, since an effect of a plurality of lenses being disposed in an overlapping manner can be acquired using a single lens, optical performance may be increased while implementing the optical system 100 in a small size.

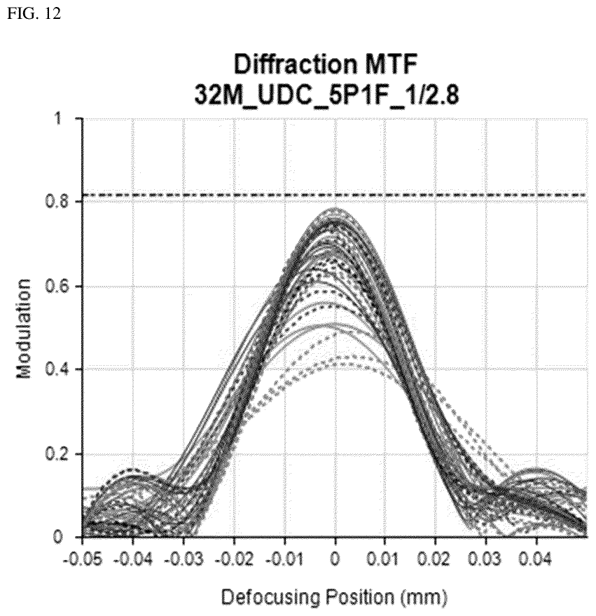

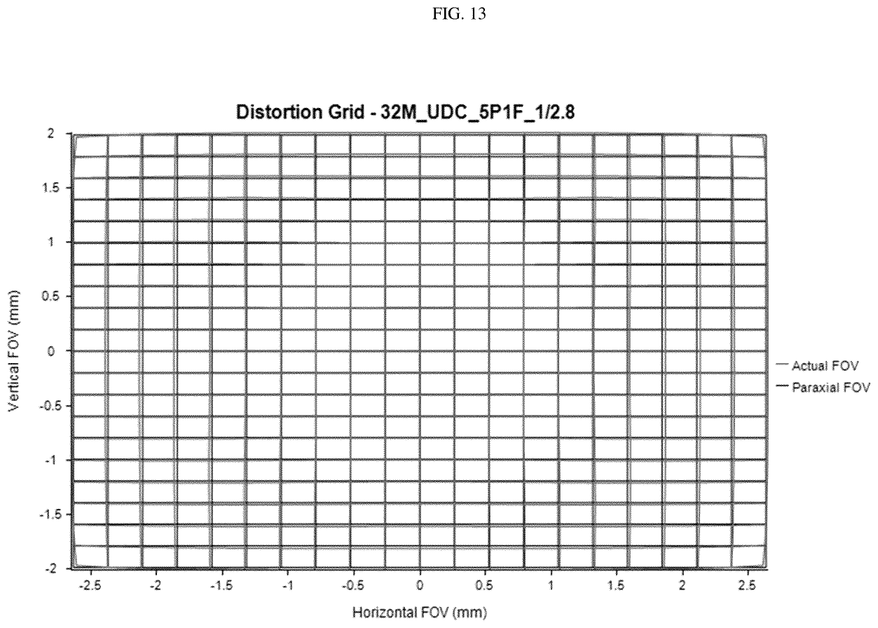

Table 5 shows chief ray angle (CRA) data and an RI value, which may be acquired using the optical system according to the embodiment of the present invention, by field, FIG. 12 shows a modulation transfer function (MTF) using the optical system according to one embodiment of the present invention, and FIG. 13 shows a distortion grid using the optical system according to one embodiment of the present invention.

TABLE 5

| Field | CRA | RI(%) |
|---|---|---|
| 0 | 0 | 100.0% |
| 0.1 | 7.79839 | 99.1% |
| 0.2 | 15.0677 | 95.3% |
| 0.3 | 21.5477 | 87.2% |
| 0.4 | 27.2865 | 76.0% |
| 0.5 | 31.9691 | 65.0% |
| 0.6 | 34.9043 | 56.8% |
| 0.7 | 35.9255 | 48.8% |
| 0.8 | 36.2047 | 40.5% |
| 0.9 | 36.2217 | 34.0% |
| 1 | 34.7212 | 31.4% |

Referring to Table 5, in the optical system according to the embodiment of the present invention, it can be seen that an amount of light at the periphery of the image sensor (1 field) excluding the 0 field is 30% or more when a chief ray angle (CRA) is 7 degrees or more, for example, in a range of 8 degrees to 37 degrees, and an amount of light at a central portion of the image sensor (0 field) is 100%.

Referring to FIG. 12, the sharpness of an image in a spatial frequency according to a pixel which may be acquired from the optical system according to one embodiment of the present invention may be acquired, and referring to FIG. 13, the degree of distortion of the image which may be acquired from the optical system according to one embodiment of the present invention may be acquired.

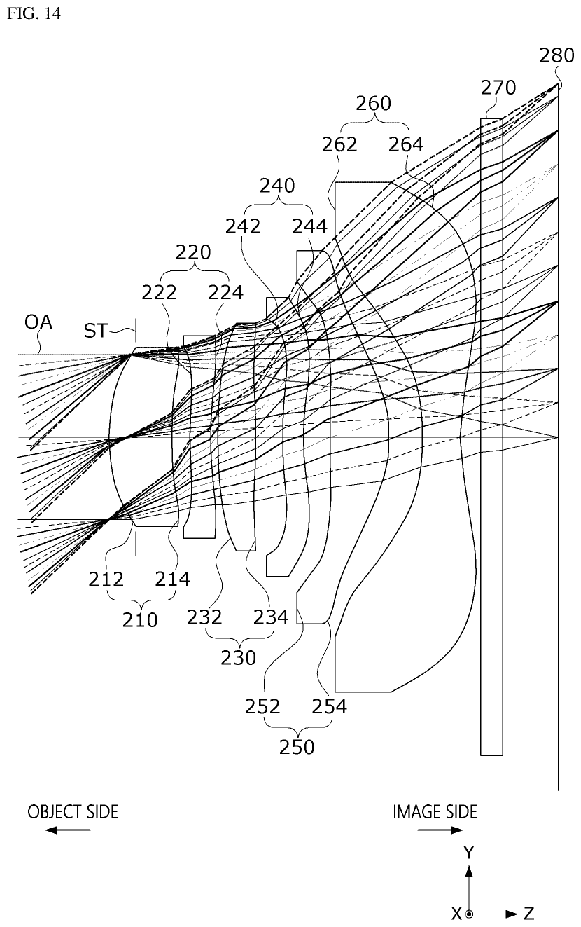

FIG. 14 is a cross-sectional view of an optical system according to a comparative example.

Referring to FIG. 14, an optical system 200 according to the comparative example includes a first lens 210, a second lens 220, a third lens 230, a fourth lens 240, a fifth lens 250, a sixth lens 260, a filter 270, and an image sensor 280, which are sequentially disposed from an object side to an image side.

Tables 6 and 7 below show the optical characteristics of the lenses included in the optical system according to the comparative example, Table 8 shows the Qcon coefficients of the first to sixth lenses included in the optical system according to the comparative example.

TABLE 6

| | Lens | | Radius of | | Effective |
|---|---|---|---|---|---|
| Lens | Surface | | Curvature | Thickness | Diameter |
| Number | Number | Shape | (R, mm) | (mm) | (mm) |
| Aperture | ST | | | 0.000 | 1.580 |
| First | 212 | Convex | 1.592 | 0.600 | 1.580 |
| Lens | 214 | Concave | 3.438 | 0.183 | 1.710 |
| Second | 222 | Convex | 4.948 | 0.200 | 1.732 |
| Lens | 224 | Concave | 2.973 | 0.068 | 1.936 |
| Third | 232 | Convex | 5.211 | 0.366 | 2.136 |
| Lens | 234 | Convex | −17.480 | 0.253 | 2.166 |
| Fourth | 242 | Convex | 2.959 | 0.204 | 2.276 |
| Lens | 244 | Concave | 2.088 | 0.247 | 2.678 |
| Fifth | 252 | Convex | 5.475 | 0.575 | 2.972 |
| Lens | 254 | Convex | −1.222 | 0.316 | 3.567 |
| Sixth | 262 | Concave | −1.858 | 0.363 | 3.806 |
| Lens | 264 | Concave | 1.776 | 0.195 | 4.853 |
| Filter | 272 | | | 0.210 | |
| | 274 | | | 0.540 | |
| Sensor | 280 | | | | |

TABLE 7

| | Lens | Focal | | | | Center | Air | Edge |
|---|---|---|---|---|---|---|---|---|
| Lens | Surface | Length | | Abbe | Refractive | Thickness | Gap | Thickness |
| Number | Number | (f, mm) | Power | Number | Index | (mm) | (mm) | (mm) |
| First | 212 | 4.9603 | 0.22 | 55.7074 | 1.5371 | 0.6000 | | 0.4575 |
| Lens | 214 | | | | | | 0.1828 | |
| Second | 222 | −11.2664 | −0.09 | 18.1193 | 1.6898 | 0.2000 | | 0.2982 |
| Lens | 224 | | | | | | 0.0681 | |
| Third | 232 | 7.5165 | 0.13 | 55.7074 | 1.5371 | 0.3656 | | 0.1999 |
| Lens | 234 | | | | | | 0.2529 | |
| Fourth | 242 | −12.5643 | −0.08 | 25.9602 | 1.6206 | 0.2043 | | 0.2147 |
| Lens | 244 | | | | | | 0.2474 | |
| Fifth | 252 | 1.9170 | 0.52 | 55.7074 | 1.5371 | 0.5747 | | 0.2499 |
| Lens | 254 | | | | | | 0.3162 | |
| Sixth | 262 | −1.6335 | −0.61 | 55.7074 | 1.5371 | 0.43630 | | 0.5500 |
| Lens | 264 | | | | | | | |
| Filter | 272 | | | | | | | |
| | 274 | | | | | | | |
| Sensor | 280 | | | | | | | |

TABLE 8

| | L1 | | L2 | | L3 | | L4 |
|---|---|---|---|---|---|---|---|
| | S1 | S2 | S1 | S2 | S1 | S2 | S1 |
| Y Radius | 1.592 | 3.438 | 4.948 | 2.973 | 5.211 | −17.480 | 2.959 |
| Normalization | 0.812 | 0.845 | 0.865 | 0.982 | 1.079 | 1.100 | 1.105 |
| Radius | | | | | | | |
| Conic Constant | −0.014 | −3.085 | −3.634 | −3.895 | 4.017 | 97.984 | −87.652 |
| 4th Order | 2.87E−03 | −2.53E−02 | −1.30E−01 | −1.19E−01 | 5.00E−02 | 2.41E−02 | −1.40E−01 |
| 6th Order | 5.15E−04 | −4.50E−03 | −5.94E−03 | 7.39E−05 | 3.76E−03 | 1.65E−02 | −2.53E−02 |
| 8th Order | 2.87E−05 | −9.58E−04 | −1.01E−03 | 9.86E−05 | 1.56E−03 | 6.36E−03 | −7.45E−03 |
| 10th Order | 2.68E−05 | −8.09E−05 | 1.02E−05 | 3.38E−04 | 3.87E−04 | 2.66E−03 | −3.98E−03 |
| 12th Order | −5.90E−06 | 5.25E−05 | 1.79E−04 | 2.52E−04 | 2.02E−04 | 1.61E−03 | −1.37E−03 |
| 14th Order | 3.41E−06 | 6.99E−05 | 1.53E−04 | 5.62E−05 | −1.94E−04 | 5.69E−04 | −4.69E−04 |
| 16th Order | −7.63E−06 | 2.30E−05 | 8.93E−05 | 7.29E−05 | 8.35E−06 | 1.88E−04 | −1.11E−04 |
| 18th Order | −9.47E−07 | 8.23E−06 | 1.67E−05 | −7.27E−06 | −5.27E−05 | 7.94E−05 | −4.50E−05 |
| 20th Order | −3.14E−06 | 1.43E−07 | 3.51E−06 | 7.43E−06 | −7.43E−06 | 2.39E−05 | −2.22E−05 |

| | L4 | L5 | | L6 | |
|---|---|---|---|---|---|
| | S2 | S1 | S2 | S1 | S2 |
| Y Radius | 2.088 | 5.475 | −1.222 | −1.858 | 1.776 |
| Normalization | 1.301 | 1.387 | 1.698 | 1.734 | 2.453 |
| Radius | | | | | |
| Conic Constant | −42.581 | −99.000 | −1.521 | −0.120 | −12.579 |
| 4th Order | −2.78E−01 | −3.34E−01 | 4.38E−01 | 1.84E−01 | −1.24E+00 |
| 6th Order | −6.67E−03 | −1.22E−03 | −3.10E−02 | 1.11E−01 | −1.99E−02 |
| 8th Order | 2.37E−03 | −5.52E−03 | −4.26E−04 | 2.09E−02 | −4.83E−02 |
| 10th Order | 1.87E−03 | 5.07E−03 | −4.58E−03 | −7.60E−03 | 3.81E−03 |
| 12th Order | 1.17E−03 | −1.19E−03 | −6.37E−04 | −1.22E−03 | 3.04E−03 |
| 14th Order | 1.04E−03 | 3.80E−04 | −1.61E−04 | −2.47E−04 | 3.99E−03 |
| 16th Order | 2.86E−04 | 1.35E−04 | 6.94E−04 | 3.60E−04 | 3.39E−03 |
| 18th Order | −9.65E−05 | 1.75E−04 | 4.46E−05 | 3.63E−04 | 1.28E−03 |
| 20th Order | −9.45E−05 | −8.03E−05 | −3.38E−04 | −1.33E−04 | 5.54E−04 |

Table 9 shows chief ray angle (CRA) data and RI values which may be acquired using the optical system according to the comparative example, by field.

TABLE 9

| Field | RI(%) |
|---|---|
| 0 | 100.0% |
| 0.1 | 96.6% |
| 0.2 | 89.4% |
| 0.3 | 79.3% |
| 0.4 | 68.4% |
| 0.5 | 58.0% |
| 0.6 | 48.8% |
| 0.7 | 41.0% |
| 0.8 | 33.2% |
| 0.9 | 26.5% |
| 1 | 19.2% |

Referring to FIG. 14 and Tables 6 to 8, it can be seen that the optical system 200 according to the comparative example has a similar design to the optical system 100 according to the embodiment of the present invention except for the sixth lens 260. That is, the optical system 200 according to the comparative example includes six lenses, and the first lens 210 closest to the object side has the smallest effective diameter among the first to sixth lenses, and the thickness of the first lens 210 is the greatest among the first to sixth lenses. However, unlike the embodiment of the present invention, the sixth lens 260 of the optical system according to the comparative example is a circular symmetrical lens. Referring to Table 9, it can be seen that the optical system according to the comparative example has an RI of 19.2% in the 1 field. It can be seen that this is significantly different from the optical system according to the embodiment having an RI of 31.4% in the 1 field.

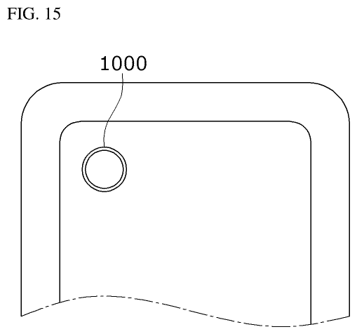

FIG. 15 is a view showing a portion of a mobile terminal to which the camera device according to one embodiment of the present invention is applied.

Meanwhile, the optical system 100 according to the embodiment of the present invention may be applied to a camera device 1000. The camera device 1000 including the optical system 100 according to the embodiment of the present invention may be built in a mobile terminal and applied along with a main camera module. The camera device 1000 according to the embodiment of the present invention may include an image sensor, a filter disposed on the image sensor, and an optical system 100 disposed on the filter, and the optical system 100 according to the embodiment of the present invention may include the above-described first lens 110, second lens 120, third lens 130, fourth lens 140, and fifth lens 150. The mobile terminal with a built-in camera device including the optical system according to the embodiment of the present invention may be a smartphone, a tablet personal computer (PC), a laptop computer, a personal digital assistant (PDA), or the like.

The optical system 100 according to the embodiment of the present invention may be sequentially disposed in a lateral direction of the mobile terminal due to the thickness constraints of the mobile terminal. To this end, as described above, a right-angled prism may be further disposed in front of the first lens 110.

The mobile terminal may be a smartphone, a tablet PC, a laptop computer, a PDA, or the like.

Although the embodiments have been mainly described above, these are merely examples and are not intended to limit the present invention, and it can be seen that various modifications and applications not exemplified herein are possible without departing from the essential characteristics of the present invention by those skilled in the art. For example, each of the components specifically shown in the embodiments may be modified and implemented. Further, it should be interpreted that differences related to the modifications and the applications are included in the scope of the present invention defined by the appended claims.

### REFERENCE NUMERALS

100: optical system
110: first lens
120: second lens
130: third lens
140: fourth lens
150: fifth lens
160: sixth lens

1. An optical system comprising first to nth lenses and an image sensor, which are sequentially disposed from an object side to an image side,
wherein the first lens has positive power and is a lens having the smallest diameter of an effective region and the greatest thickness among the first to nth lenses,
the first to n−1th lenses have positive composite power,
the nth lens has negative power,
at least one of an object-side surface and an image-side surface of the nth lens includes a critical point at which a tilt angle is 0,
sag values of a critical point of an X-axis, a critical point of a Y-axis, and a critical point in one direction between the X-axis and the Y-axis of at least one of the object-side surface and the image-side surface of the nth lens are different from each other,
the X-axis is perpendicular to the optical axis and parallel to one side of the image sensor,
the Y-axis is perpendicular to the optical axis and the X-axis, and
n is an integer greater than or equal to 6.

2. The optical system of claim 1, wherein a ratio of a diameter of the effective region of the first lens to a diagonal length of the image sensor is 0.15 or more and 0.35 or less.

3. The optical system of claim 1, wherein a center thickness on the optical axis is the greatest in the first lens among the first to nth lenses, and
a thickness at an end of the effective region is the next greatest in the first lens after the nth lens among the first to nth lenses.

4. The optical system of claim 1, wherein when a center thickness on the optical axis of the first lens is CT1, a distance from the object-side surface of the first lens to the image sensor is TTL, and the sum of the center thicknesses on the optical axis of the first lens to the nth lens is CT_1n,
CT1/TTL is 0.1 or more and 0.2 or less, and
CT1/CT_1n is 0.2 or more and 0.35 or less.

5. The optical system of claim 1, wherein n is 6.

6. The optical system of claim 1, wherein a deviation between the sag value of the critical point of the X-axis and a sag value of a critical point in a direction formed at 45 degrees from the X-axis of at least one of the object-side surface and the image-side surface of the nth lens is greater than a deviation between the sag value of the critical point of the X-axis and the sag value of the critical point of the Y-axis of at least one of the object-side surface and the image-side surface of the nth lens.

7. The optical system of claim 1, wherein an absolute value of a sag value of a critical point in a direction formed at 45 degrees from the X-axis is the smallest among an absolute value of the sag value of the critical point of the X-axis, an absolute value of the sag value of the critical point of the Y-axis, and the absolute value of the sag value of the critical point in the direction formed at 45 degrees from the X-axis of at least one of the object-side surface and the image-side surface of the nth lens.

8. The optical system of claim 1, wherein an absolute value of a deviation between at least two of a sag value of the X-axis, a sag value of the Y-axis, a sag value in a direction formed at 45 degrees from the X-axis, and a sag value in a diagonal direction of the image sensor from a point of 50% of the effective region to an end of the effective region of at least one of the object-side surface and the image-side surface of the nth lens is 2 μm or more.

9. The optical system of claim 1, wherein both an object-side surface and an image-side surface of the sixth lens have a circular asymmetrical shape.

10. An optical system comprising first to nth lenses and an image sensor, which are sequentially disposed from an object side to an image side,
wherein the first lens has positive power,
a ratio of a diameter of an effective region of the first lens to a diagonal length of the image sensor is 0.15 or more and 0.35 or less,
the first to n−1th lenses have positive composite power,
the nth lens has negative power,
at least one of an object-side surface and an image-side surface of the nth lens includes a critical point at which a tilt angle is 0,
sag values of a critical point of an X-axis, a critical point of a Y-axis, and a critical point in one direction between the X-axis and the Y-axis of at least one of the object-side surface and the image-side surface of the nth lens are different from each other,
the X-axis is perpendicular to the optical axis and parallel to one side of the image sensor,
the Y-axis is perpendicular to the optical axis and the X-axis, and
n is an integer greater than or equal to 6.

11. The optical system of claim 1, wherein the second lens has negative refractive power, the third lens has positive refractive power, the fourth lens has negative refractive power, and the fifth lens has positive refractive power.

12. The optical system of claim 1, wherein an aperture is disposed on the front of the object-side surface of the first lens, and when the aperture is closed, the shortest distance between the aperture and the object-side surface of the first lens is 0.2 mm or less.

13. The optical system of claim 1, wherein a diameter of the effective region of the image-side surface of the sixth lens is 1.2 times or more a diameter of the effective region of the object-side surface of the first lens.

14. The optical system of claim 1, wherein the object-side surface or image-side surface of at least one of the first to n−1th lenses includes a critical point.

15. The optical system of claim 14, wherein an object-side surface and an image-side surface of the fourth lens each include a critical point, and a distance between the optical axis and the critical point of the object-side surface of the fourth lens is 0.95 to 1.05 times a distance between the optical axis and the critical point of the image-side surface of the fourth lens.

16. The optical system of claim 1, wherein a center thickness of the second lens or a center thickness of the fourth lens is the smallest among center thicknesses of the first to nth lenses.

17. The optical system of claim 1, wherein a F-number is 2.3 or less, a field of view (FOV) is 85 degrees or more, and a relative illumination (RI) is 30% or more.

18. An optical system comprising first to nth lenses and an image sensor, which are sequentially disposed from an object side to an image side,
wherein the first lens has positive power,
the first to n−1th lenses have positive composite power,
the nth lens has negative power,
at least one of an object-side surface and an image-side surface of the nth lens includes a critical point at which a tilt angle is 0,
sag values of a critical point of an X-axis, a critical point of a Y-axis, and a critical point in one direction between the X-axis and the Y-axis of at least one of the object-side surface and the image-side surface of the nth lens are different from each other,
the X-axis is perpendicular to the optical axis and parallel to one side of the image sensor,
the Y-axis is perpendicular to the optical axis and the X-axis, and
n is 6.

19. The optical system of claim 18, wherein a center thickness on the optical axis is the greatest in the first lens among the first to nth lenses, and
a thickness at an end of the effective region is the next greatest in the first lens after the nth lens among the first to nth lenses.

20. The optical system of claim 18, wherein when a center thickness on the optical axis of the first lens is CT1, a distance from the object-side surface of the first lens to the image sensor is TTL, and the sum of the center thicknesses on the optical axis of the first lens to the nth lens is CT_1n,
CT1/TTL is 0.1 or more and 0.2 or less, and
CT1/CT_1n is 0.2 or more and 0.35 or less.
